(19) United States
(12) Patent Application Publication
(10) Pub. No.: US 2008/0120623 A1
(43) Pub. Date: May 22, 2008

(54) Work-flow apparatus, work-flow process, and computer-readable medium storing work-flow program

(75) Inventors: Hiroaki Harada, Kawasaki (JP); Jun Arima, Kawasaki (JP); Akihiko Obata, Kawasaki (JP); Takanori Ukai, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/901,343

(22) Filed: Sep. 17, 2007

(30) Foreign Application Priority Data
Nov. 22, 2006 (JP) 2006-315948

(51) Int. Cl. G06F 9/445

(52) U.S. Cl. 718/105

(57) ABSTRACT

In a work-flow process, a work-flow apparatus, and a computer-readable medium storing a work-flow program for delivering work requests to stations in an organization: a station in charge of executing each work request is determined by comparing the work request with work definitions, and the work request is delivered to the station in charge; acceptance or rejection of the work request by the station in charge is recorded in a request-processing history in association with an identifier of the work request; and the number of work requests which have been improperly or indirectly delivered to each station is obtained on the basis of the numbers of work requests which have been rejected by the station. When the number of work requests which have been improperly or indirectly delivered to each station is greater than a predetermined number, the work definition for the station is determined to be corrected.

### CROSS-REFERENCE TO RELATED APPLICATIONS

This application is based upon and claims the benefits of priority from the prior Japanese Patent Application No. 2006-315948 filed on Nov. 22, 2006, the entire contents of which are incorporated herein by reference.

### BACKGROUND OF THE INVENTION

1. Field of the Invention

The present invention relates to a work-flow apparatus, a work-flow process, and a computer-readable medium storing a work-flow program for managing distribution of work requests among a plurality of stations in an organization, and in particular to a work-flow apparatus, a work-flow process, and a computer-readable medium storing a work-flow program storing a software management program which manage distribution of work requests among a plurality of stations in an organization by comparing each work request with work definitions respectively defining work operations to be performed by the plurality of stations.

2. Description of the Related Art

In the organizations consisting of a plurality of stations such as enterprises, central and local government offices, and the like, details of work activities of the respective stations are defined. Hereinafter, the definitions of works are referred to as the work definitions. The stations perform the work operations corresponding to the work definitions, respectively. In the case where work definitions as above are set in advance in a computer system, the computer system can automatically distribute work requests among the plurality of stations.

According to a known technique related to the work definition, information on works is collected and analyzed, for example, as indicated in Japanese Unexamined Patent Publication No. 2002-222307. According to another known technique, a work-related decision-making process is determined by comparing each work-related inquiry with classification conditions provided for classifying work-related inquiries, for example, as indicated in Japanese Unexamined Patent Publication No. 2003-76686.

However, according to the conventional techniques, it is impossible to detect a mismatch between the work definitions. For example, when the work definitions for each station are unclear, or when liaison between the stations is insufficient and information is not shared between the stations, a mismatch between the work definitions is likely to occur. In such cases, one or more of the stations do not know the extent of works in one or more other stations, so that the activities of different stations overlap, or no station becomes responsible for some works. Therefore, even if the organization receives an inquiry from another organization, a customer, a person, or the like, the station responsible for the inquiry is not determined, so that the inquiry can be transferred around from one station to another.

In addition, even in the case where the work definitions for the respective stations are correctly defined, in many cases, the work definitions are not updated with changes in the extent of responsibility of each station. Therefore, the work definitions can depart from the actual condition when time elapses. This is because description of the work definitions is left to the work site or the administrative segment, and no provision is made for ensuring updating of the work definitions.

Further, conventionally the work definitions are often unclearly described, and the unclear description of the work definitions is likely to cause misinterpretation and impair correctness of distribution of work requests based on the work definitions.

Furthermore, unclear description of activities of the organization can decrease awareness of responsibility among the organization members, and lower the quality of the activities of the organization.

### SUMMARY OF THE INVENTION

The first object of the present invention is to provide a work-flow process and a work-flow apparatus which manage distribution of work requests among a plurality of stations in an organization, and can detect a mismatch between work definitions.

The second object of the present invention is to provide a computer-readable medium storing a work-flow program which manages distribution of work requests among a plurality of stations in an organization, and can detect a mismatch between work definitions.

In order to accomplish the first object, according to the first aspect of the present invention, a work-flow apparatus for delivering work requests for work operations to a plurality of stations in an organization is provided. The work-flow apparatus comprises: a work definition storing unit which stores a plurality of work definitions for the plurality of stations, where work operations to be performed by the plurality of stations are defined in the plurality of work definitions, respectively; a history storing unit which stores request-processing histories of the plurality of stations, where the request-processing histories indicate how one or more work requests have been handled by stations designated to be in charge of executing the one or more work requests; a request receiving unit which receives a work request for a work operation; a station-in-charge determination unit which detects a station for which a work definition covering the work operation requested by the work request is stored in the work definition storing unit, by comparing the work request received by the request receiving unit with the plurality of work definitions stored in the work definition storing unit, and determines the detected station to be a station in charge of executing the work request; a request output unit which delivers the work request to a terminal used in the station in charge; an acceptance-determination acquisition unit which acquires from the terminal acceptance information indicating whether or not the station in charge accepts the work request which is delivered by the request output unit, and reflects the acceptance information in the request-processing histories so that the acceptance information is associated with an identifier of the work request; and a definition-to-be-corrected detection unit which obtains as a statistic for each of the plurality of stations the number of work requests which have been improperly or indirectly delivered to the station, on the basis of the numbers of work requests which have been rejected by the station, and detects one of the plurality of stations for which the statistic is equal to or greater than a predetermined number, as a station for which one of the plurality of work definitions is to be corrected, where the numbers of work requests which have been rejected by the plurality of stations are respectively indicated in the request-processing histories stored in the history storing unit.

In addition, in order to accomplish the first object, according to the second aspect of the present invention, a work-flow process for delivering work requests for work operations to a plurality of stations in an organization is also provided. The work-flow process comprises the steps of: (a) receiving a work request for a work operation; (b) detecting a station for which a work definition covering the work operation requested by the work request is stored in advance, by comparing the work request received in step (a) with a plurality of work definitions which are stored in advance, and determining the detected station to be a station in charge of executing the work request; (c) delivering the work request to a terminal used in the station in charge; (d) acquiring from the terminal acceptance information indicating whether or not the station in charge accepts the work request which is delivered in step (c), and reflecting the acceptance information in request-processing histories so that the acceptance information is associated with an identifier of the work request; and (e) obtaining as a statistic for each of the plurality of stations the number of work requests which have been improperly or indirectly delivered to the station, on the basis of the numbers of work requests which have been rejected by the station, and detecting one of the plurality of stations for which the statistic is equal to or greater than a predetermined number, as a station for which one of the plurality of work definitions is to be corrected, where the numbers of work requests which have been rejected by the plurality of stations are respectively indicated in request-processing histories, which are stored in advance in correspondence with the plurality of stations, respectively.

Further, in order to accomplish the second object, a computer-readable medium storing a work-flow program which makes a computer realize the aforementioned work-flow apparatus according to the first aspect of the present invention is provided.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a diagram illustrating an outline of the present invention.

FIG. 2 is a diagram illustrating an example of a system configuration according to a first embodiment of the present invention.

FIG. 3 is a diagram illustrating a hardware construction of a work-flow management server used in the first embodiment.

FIG. 4 is a block diagram illustrating the functions of the work-flow management server according to the first embodiment.

FIG. 5 is a diagram illustrating a structure of an organization.

FIG. 6 is a diagram illustrating an example of a work definition.

FIG. 7 is a diagram illustrating an example of a work definition table.

FIG. 8 is a diagram illustrating an example of a data structure of a request-information set.

FIG. 9 is a diagram illustrating an example of a data structure of a request-processing history.

FIG. 10 is a flow diagram indicating an example of a data structure of a request-processing-history table.

FIG. 11 is a schematic diagram indicating an example of forwarding of request information.

FIG. 12 is a flow diagram indicating a sequence of processing according to the first embodiment of the present invention.

FIG. 13 is a flow diagram indicating a sequence of processing for inputting work definitions FIG. 14 is a flow diagram indicating a sequence of processing for confirming the work definitions.

FIG. 15 is a flow diagram indicating a sequence of processing for producing request information.

FIG. 16 is a flow diagram indicating a sequence of processing for determining a station in charge of a work request.

FIG. 17 is a flow diagram indicating a sequence of processing for accepting a work request.

FIG. 18 is a flow diagram indicating a sequence of processing for updating the request-processing history.

FIG. 19 is a flow diagram indicating a sequence of processing for recommending update of work definitions.

FIG. 20 is a flow diagram indicating a sequence of processing for updating work definitions.

FIG. 21 is a diagram illustrating an example of the request-processing history.

FIG. 22 is a diagram illustrating an example of updating of the work definitions.

FIG. 23 is a diagram illustrating an example of a work definition table after the work definitions are updated.

FIG. 24 is a diagram illustrating an example of an operation of making a list of all stations which can execute a work request.

FIG. 25 is a block diagram illustrating the functions of a work-flow management server according to a second embodiment of the present invention.

FIG. 26 is a diagram illustrating an example of a data structure of a request database according to the second embodiment of the present invention.

FIG. 27 is a flow diagram indicating a sequence of processing according to the second embodiment.

FIG. 28 is a flow diagram indicating a sequence of processing for initializing work definitions.

FIG. 29 is a flow diagram indicating a sequence of processing for directly delivering request information.

FIG. 30 is a flow diagram indicating a sequence of processing for storing the work definitions.

FIG. 31 is a flow diagram indicating a sequence of processing for updating the work definitions.

### DESCRIPTION OF THE PREFERRED EMBODIMENTS

Preferred embodiments of the present invention will be described below with reference to the accompanying drawings. First, an outline of the present invention which is realized in the embodiments is indicated, and thereafter details of the embodiments are explained.

### 1. Outline of the Present Invention

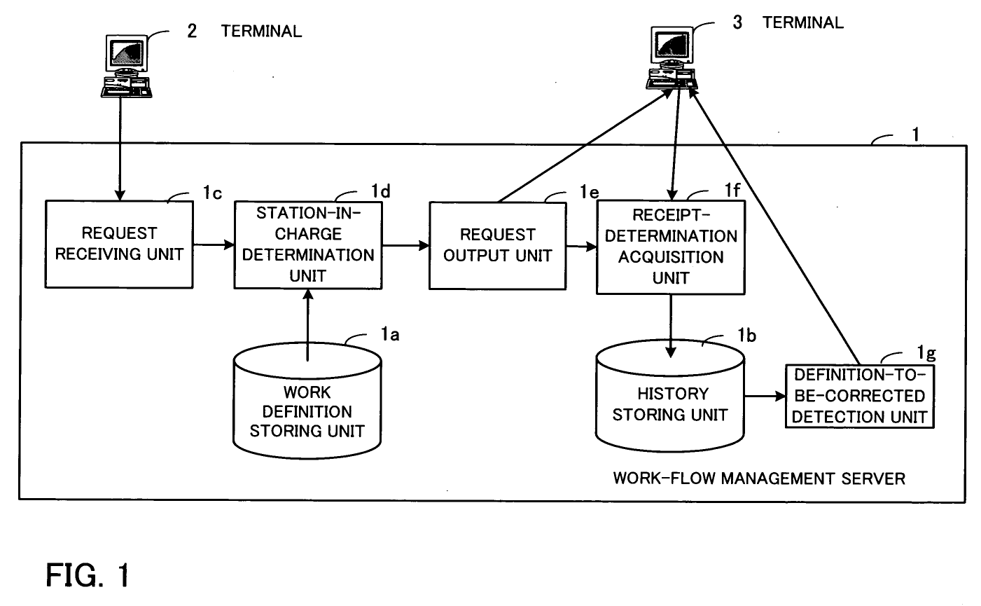

FIG. 1 is a diagram illustrating an outline of the present invention. In the construction of FIG. 1, the work-flow management server 1 is connected to a plurality of terminals 2 and 3. In the example of FIG. 1, the terminal 2 is used for requesting a work, and the terminal 3 is used for inputting a result of determination whether or not a request for a work (work request) is accepted by a station which performs an operation for a work.

The work-flow management server 1 comprises a work definition storing unit 1a, a history storing unit 1b, a request receiving unit 1c, a station-in-charge determination unit 1d, a request output unit 1e, an acceptance-determination acquisition unit 1f, and a definition-to-be-corrected detection unit 1g.

The work definition storing unit 1a stores a work definition for each station, where a work operation to be performed by the station is defined in the work definition. For example, the work definition contains an article as an object for which a service is to be provided, a feature of the service to be provided, and a service area in which the service is to be provided.

The history storing unit 1b stores request-processing histories. Each of the request-processing histories indicates one or more work operations which have been performed by a station designated to be in charge of executing one or more work requests. Each of the request-processing histories includes acceptance information and forwarding information. The acceptance information indicates whether or not each work request designating a station in charge of executing the work request is accepted by the station, and the forwarding information indicates a destination (another station) to which each work request is forwarded from the designated station in charge.

The request receiving unit 1c receives a work request indicating a description of a requested work operation. For example, the description of the work request designates an article as an object of the service, a feature of the service to be provided, and a service area in which the service is to be provided.

The station-in-charge determination unit id detects a station for which a work definition covering the requested work operation indicated in the work request is set, by comparing the work request received by the request receiving unit 1c with the work definitions stored in the work definition storing unit 1a, and determines the detected station to be in charge of executing the work request. In the case where the organization has a tree structure, the station-in-charge determination unit id searches for the station in which a work definition covering the requested work operation indicated in the work request is set (stored in the work definition storing unit 1a), by tracing the tree structure.

In the case where a person belonging to a station determined by the station-in-charge determination unit id to be in charge of executing a work request uses the terminal 3, the request output unit 1e sends a work request to the terminal 3. For example, when the request output unit 1e receives a request for reference to a work request which the above station has charge of, the request output unit 1e sends the work request to the terminal 3.

The acceptance-determination acquisition unit 1f acquires from the terminal 3 (which the person belonging to the above station uses) acceptance information indicating whether or not the station to which the above person using the terminal 3 belongs accepts the work request which the station has charge of, and stores in the history storing unit 1b a request-processing history in which the acceptance information is associated with an identifier of the work request. When the above station rejects the work request, a station to which the work request is forwarded may be designated. In this case, forwarding information indicating the station to which the work request is forwarded is contained in the request-processing history.

The definition-to-be-corrected detection unit 1g obtains as a statistic for each station the number of work requests which have been improperly or indirectly delivered to each of the stations, on the basis of the number of work requests which have been rejected by the station (which is indicated in the request-processing histories stored in the history storing unit 1b), and detects a station for which the above statistic is equal to or greater than a predetermined number. Further, the number of work requests forwarded to the above station may be added to the above statistic. In this specification, the expression “a request has been properly executed by a station” means that a work request which has been accepted and executed by a station, and the expression “a request has been improperly or indirectly delivered to a station” means either that (1) a station has rejected a work request which has been delivered to the station so that the work request has been forwarded to another station, or (2) a station has accepted a work request which has been forwarded to the station after the work request has first been delivered to another station.

In the work-flow management server 1 having the above functions, the request receiving unit 1c can receive a work request inputted into the work-flow management server 1. Then, the station-in-charge determination unit 1d compares the received work request with the work definitions stored in the work definition storing unit 1a, detects a station for which a work definition covering the requested work operation indicated in the work request is set (stored in the work definition storing unit 1a), and determines the detected station to be in charge of executing the work request. Next, the request output unit 1e delivers the work request to the terminal 3, which is used by the person belonging to the station in charge of executing the work request. Thereafter, the acceptance-determination acquisition unit 1f acquires from the terminal 3 the acceptance information indicating whether or not the station in charge accepts the work request delivered to the terminal 3, and stores in the history storing unit 1b in the history storing unit 1b a request-processing history in which the acceptance information is associated with an identifier of the work request. In addition, the definition-to-be-corrected detection unit 1g obtains as a statistic for each station the number of work requests which have been improperly or indirectly delivered to each of the stations, on the basis of the number of work requests which have been rejected by the station, and detects a station for which the statistic is equal to or greater than the predetermined number.

In other words, according to the present invention, the information contained in the received work request is compared with the work definitions, so that a station for which a work definition covering the requested work operation indicated in the work request is stored in advance is determined to be in charge of executing the work request. At this time, if the work definitions stored in the work-flow management server are incorrect, the requested work operation indicated in the work request can deviate from the work definition for the station determined to be in charge of executing the work request. In this case, the station in charge determines not to accept the work request. Since the result of the determination whether or not the work requests have been accepted by each station is stored in the corresponding request-processing history, each station can count the number of determinations not to accept a work request. Therefore, it is possible to consider that each station making a great number of determinations not to accept a work request (i.e., having a great number of work requests which have been improperly or indirectly delivered) has a work definition which does not match the actual work condition.

For example, it is possible to recommend the station the work definition for which does not match the actual work condition to correct the work definition. When a station is recommended to the correction the work definition, the station can correct the work definition for the station on the basis of the history of the received work request.

Consequently, it is possible to timely update the work definition through the execution of the work request. In other words, it is possible to immediately correct the work definition when the work definition does not match the actual work condition.

In addition, according to the present invention, it is possible to clearly define the work responsibility in the organization. That is, correctness of the work definitions can be ensured by the quick correction of mismatches in the work definitions. Consequently, it is possible to reduce the number of wrongly delivered work requests (i.e., the number of work requests forwarded to other stations after being first delivered). This also means that inquiries received from the outside of the organization can also be quickly executed without being transferred around from one station to another.

Further, it is also possible to automatically update the work definitions according to information included in accepted work requests. For example, a requested work operation indicated in a work request accepted by each station may be added to the work definition for the station. In addition, a requested work operation indicated in a work request which is rejected by each station may be removed from the work definition for the station. In the case where updating of the work definitions is automatized, it is unnecessary to manually input complex work definitions. That is, the work definitions can be automatically updated through the normal execution of work requests, so that the work load imposed on the person belonging to each station can be reduced.

Furthermore, it is possible to prepare a plurality of operational modes, for example, an initial storage mode and a normal mode.

In the initial storage mode, information on a plurality of work requests to be executed is produced within the organization, and an optimum station suitable for execution of each work request is searched for and determined by various means (such as telephone or word-of-mouth communication, or instructions), so that the work request is executed in the station. At this time, key information on the work request (e.g., the object of the service, the feature of the service, and the service area) is stored as a work definition (item) for the station.

After the plurality of work requests are executed, and the work definitions for the respective stations are stored, the system is switched to the normal mode, in which work requests are executed in accordance with the work definitions. In the normal mode, information contained in each work request received by the system is compared with the work definitions for the respective stations. When a work definition covering the requested work operation indicated in the work request is detected, the work request is executed in the station corresponding to the work definition. When a work request is forwarded from a first station to a second station or a work request is forwarded from a third station to the first station although the requested work operation matches the work definition for the first station stored in the work-flow management server, correction processing (processing for updating the work definition) is performed. In the correction processing, work requests forwarded from the first station to the second station or from the third station to the first station are extracted, and information on the work requests is added to or deleted from the work definition for the first station.

### 2. First Embodiment

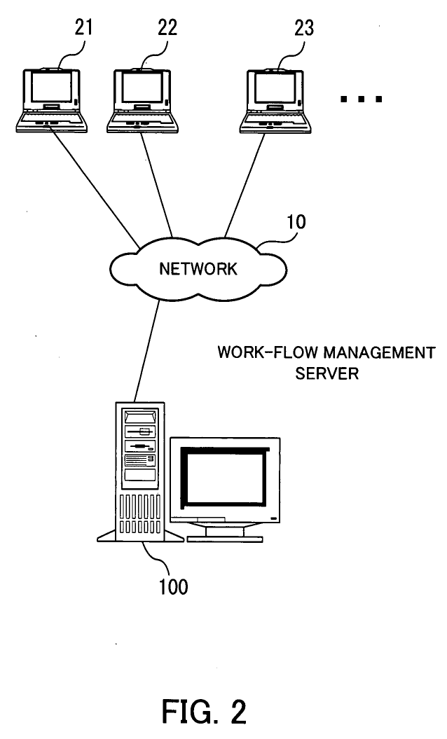

Hereinbelow, details of the preferred embodiments are explained with reference to FIGS. 2 to 31. First, the first embodiment is explained with reference to FIGS. 2 to 24.

### 2.1 System Configuration

FIG. 2 is a diagram illustrating an example of a configuration of a work-flow system according to the first embodiment of the present invention. In the work-flow system according to the first embodiment, a plurality of clients 21, 22, 23, . . . are connected to a work-flow management server 100 through a network 10. The work-flow management server 100 distributes work requests among stations in charge on the basis of work definitions (which are registered in advance), and manages forwarding of the distributed work requests to stations other than the stations to which work requests are first distributed, in response to instructions from users. In addition, the work-flow management server 100 monitors the state of the forwarding of the work requests, detects mismatches in the work definitions, and recommends correction of the work definitions.

The clients 21, 22, 23, . . . are computers used by the users. The users manipulate the clients 21, 22, 23, . . for requesting works. In addition, the users can instruct the work-flow management server 100 to forward work requests to other stations, by manipulating the clients 21, 22, 23, . . . .

### 2.2 Hardware Construction

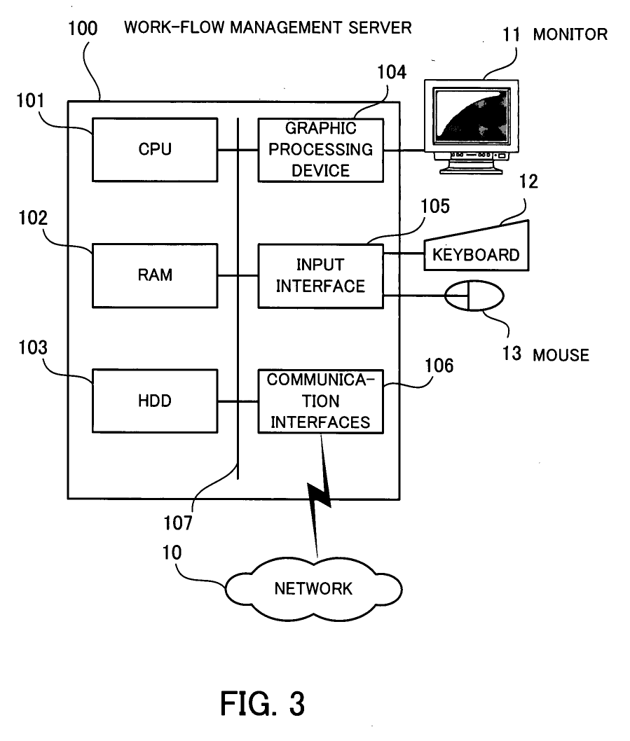

Hereinbelow, the hardware construction of the work-flow management server 100 is explained. Since each of the clients 21, 22, 23, . . . has a similar hardware construction to the work-flow management server 100, only the hardware construction of the work-flow management server 100 is explained below. FIG. 3 is a diagram illustrating a hardware construction of the work-flow management server used in the first embodiment. The entire work-flow management server 100 is controlled by a CPU (central processing unit) 101, to which a RAM (random access memory) 102, an HDD (hard disk drive) 103, a graphic processing device 104, an input interface 105, and a communication interface 106 are connected through a bus 107. The RAM 102 temporarily stores at least portions of an OS (operating system) program and application programs which are executed by the CPU 101, as well as various types of data necessary for processing by the CPU 101. The HDD 103 stores the OS program and the application programs. A monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 107. The communication interface 106 is connected to the network 10, and exchanges data with other computers through the network 10.

By using the above hardware construction, it is possible to realize the functions of the work-flow management server 100 according to the first embodiment. As mentioned before, each of the clients 21, 22, 23, . . . can also be realized by using a similar hardware construction.

### 2.3 Functions of Work-flow Management Server

Hereinbelow, the functions of the work-flow management server 100 are explained.

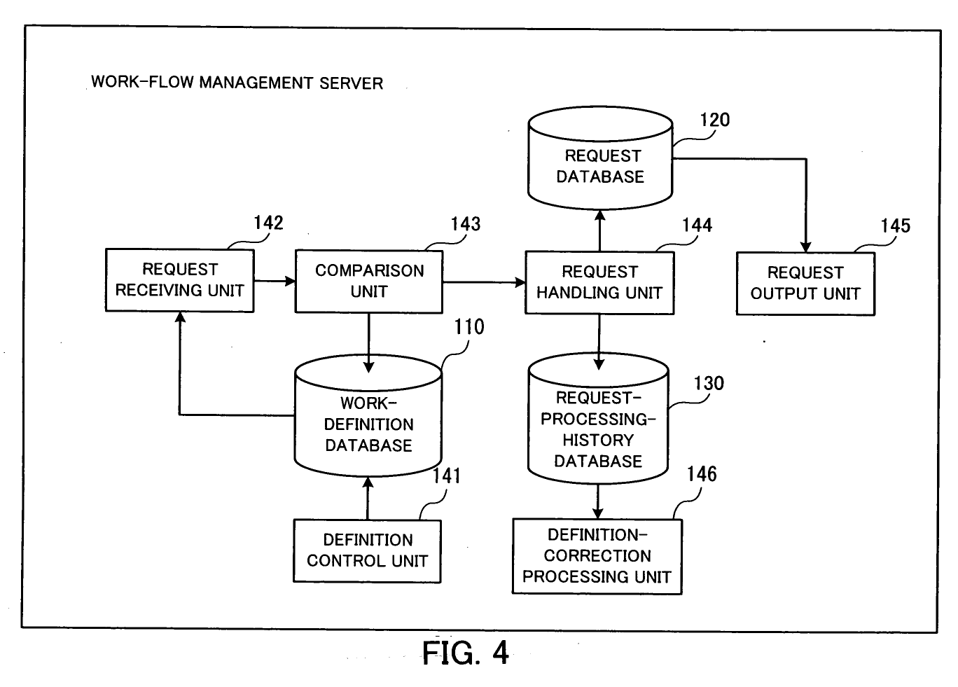

First, the functions of the work-flow management server 100 are explained with reference to FIG. 4, which is a block diagram illustrating the functions of the work-flow management server 100. The work-flow management server 100 comprises a work definition database (DB) 110, a request DB 120, a request-processing-history DB 130, a definition control unit 141, a request receiving unit 142, a comparison unit 143, a request handling unit 144, a request output unit 145, and a definition-correction processing unit 146.

The work definition DB 110 is a database which stores the work definitions. The request DB 120 is a database which stores information on work requests (request-information sets). The request-processing-history DB 130 is a database which stores the request-processing histories. For example, portions of the storage area of the HDD 103 are used as the work definition DB 110, the request DB 120, and the request-processing-history DB 130, respectively.

The definition control unit 141 receives from the clients 21, 22, 23, . . . the work definitions for the respective stations, and stores the received work definitions in the work definition DB 110. In addition, the definition control unit 141 corrects the work definitions stored in the work definition DB 110, in response to inputs through the clients 21, 22, 23, . . . .

The request receiving unit 142 receives work requests which are inputted from the clients 21, 22, 23, . . . for requesting concrete works. Then, the request receiving unit 142 produces request-information sets (request information) on the basis of information contained in the received work requests, and passes the request-information sets to the comparison unit 143.

The comparison unit 143 acquires a request-information set from the request receiving unit 142, and compares the request-information set with the work definition for each station stored in the work definition DB 110, so that the comparison unit 143 determines a station which should perform a work operation indicated in the request-information set. In addition, the comparison unit 143 passes to the request handling unit 144 the request-information set and an instruction to forward the request-information set to a determined station.

The request handling unit 144 acquires the request-information set and stores the request-information set in the request DB 120. In addition, the request handling unit 144 receives from a user a notice of acceptance or forwarding of a work request. When the request handling unit 144 receives a notice of forwarding, the request handling unit 144 changes the destination of the request-information set to a station which is designated in the notice of forwarding. Further, the request handling unit 144 stores in the request-processing-history DB 130 a result of processing (acceptance or forwarding) as a part of the request-processing histories.

The request output unit 145 transmits a request-information set in response to a request for acquisition of the request-information set, when the work-flow management server 100 receives the request for acquisition of the request-information set from the clients 21, 22, 23, . . . .

The definition-correction processing unit 146 determines a station for which the work definition does not match the actual work condition, on the basis of the request-processing histories stored in the request-processing-history DB 130, and recommends the determined station to correct the work definition, for example, by sending to a user of the determined station an e-mail indicating the recommendation of correction.

The work-flow management server 100 having the above functions can distribute work requests among stations in an organization such as an enterprise.

### 2.4 Structure of Organization

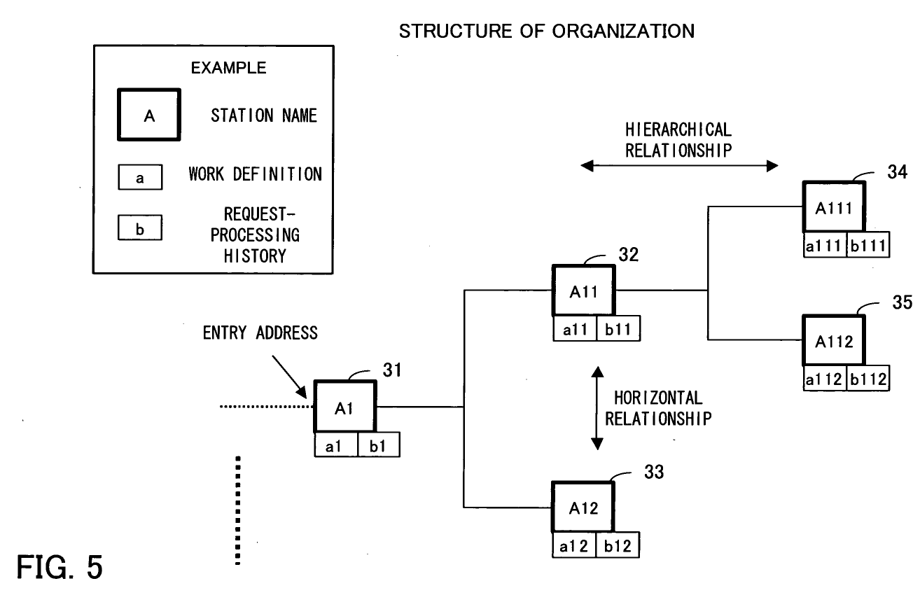

FIG. 5 is a diagram illustrating an example of a structure of an organization. The organization of FIG. 5 is constituted by a plurality of stations 31 to 35, which are respectively indicated by thick solid rectangles, and the names “A1,” “A11,” “A12,” “A111,” and “A112” of the stations 31 to 35 are indicated in the thick solid rectangles. In FIG. 5, higher-layer stations are indicated on the left side of lower-layer stations. Normally, each station having one or more subordinate stations assumes responsibility for all of the one or more subordinate stations.

The relationships between the stations in the organization (which is, for example, an enterprise or a group) can be represented in a tree (pyramidal) structure. The relationships between two stations include hierarchical relationships and horizontal relationships. In FIG. 5, the hierarchical relationships are indicated by the solid lines connecting a station and a subordinate station, and the horizontal relationships are relationships between stations which share a common superior station (as the relationship between the stations 32 and 33 which are immediately subordinate to the station 31).

In addition, in FIG. 5, the work definitions “a1,” “a11,” “a12,” “a111,” and “a112” and the request-processing histories “b1,” “b11,” “b12,” “b111,” and “b112” for the respective stations 31 to 35 are indicated under the corresponding thick solid rectangles. In practice, the work definitions are stored in the work definition DB 110, and the request-processing histories are stored in the request-processing-history DB 130.

Each work request is first forwarded to a station which is designated by an entry address indicated in the work request (i.e., the station 31 in the example of FIG. 5), and a station which has a work definition corresponding to the requested work operation is searched for from the station 31 (as the start point).

### 2.5 Work Definition

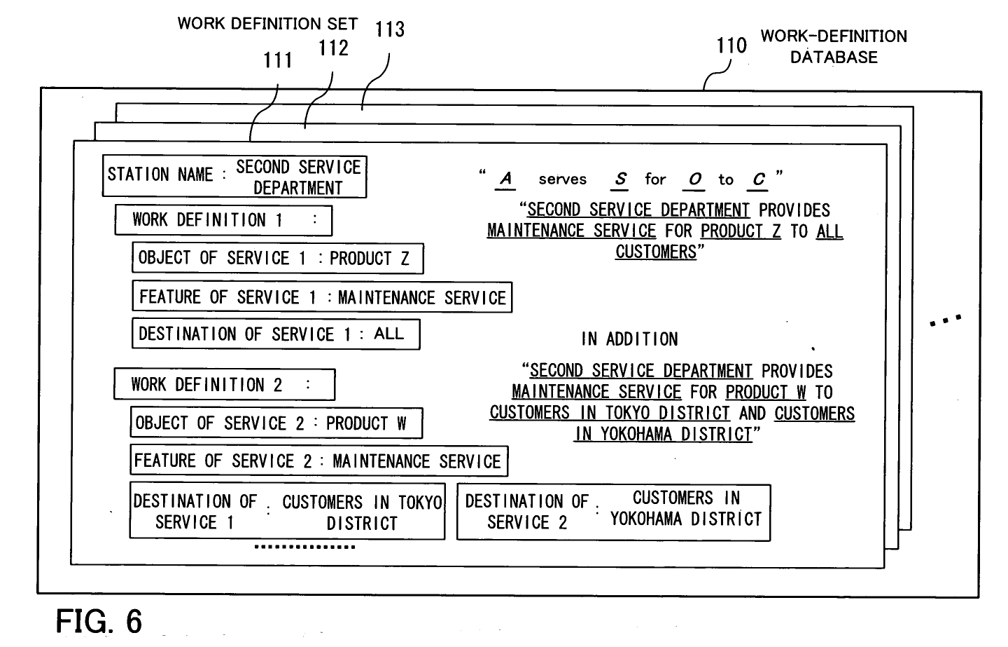

In order to distribute work requests over the above organization, the work definitions for the stations are stored in advance in the work definition DB 110. FIG. 6 is a diagram illustrating an example of a work definition. The work definition DB 110 in FIG. 6 contains work definition sets 111, 112, 113, . . . for the stations, respectively. According to the first embodiment, every work is expressed with three dimensions, the object (article), the feature of the service related to the object, and the customer, which are respectively indicated by “O,” “S,” and “C.”

Each of the work definition sets 111, 112, 113, . . . contains the name of a station and one or more work definition items. Each of the work definition items is expressed with the object of the service, the feature of the service, and the destination of the service. For example, the first work definition item in the work definition set 111 for the “Second Service Department” indicates “Product Z” as the object of the service, “Maintenance Service” as the feature of the service, and “All” as the destination of the service. This indicates that “the Second Service Department provides the Maintenance Service to all the customers.” In addition, the second work definition item in the work definition set 111 for the “Second Service Department” indicates “Product W” as the object of the service, “Maintenance Service” as the feature of the service, and “Customers in Tokyo District” and “Customers in Yokohama District” as the destinations of the service. This indicates that “the Second Service Department provides the Maintenance Service to the customers in the Tokyo and Yokohama districts.” That is, it is possible to set a plurality of work definition items for a single station.

When the work definition items are set, a work definition table is produced on the basis of the work definition items, and stored in the work definition DB 110.

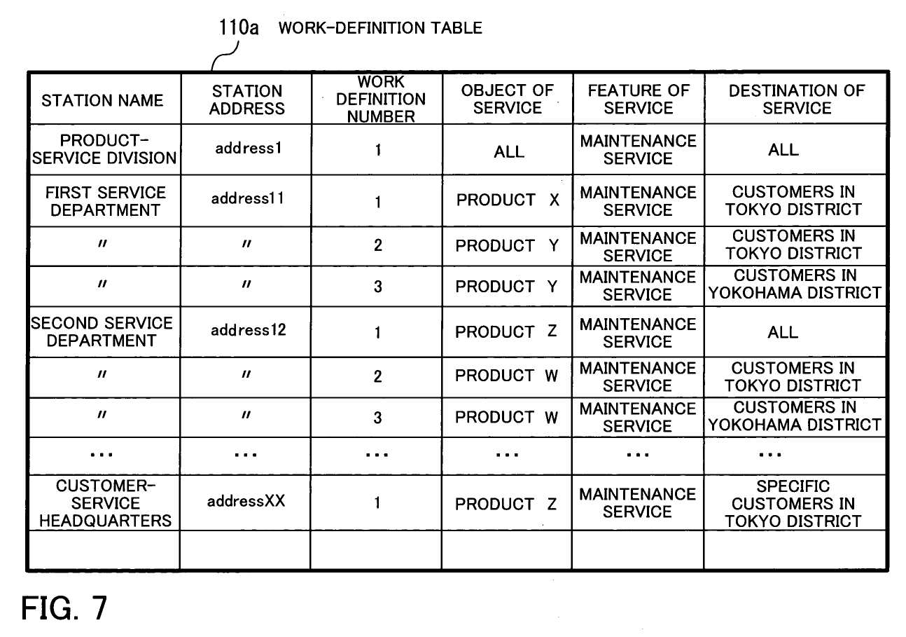

FIG. 7 is a diagram illustrating an example of a work definition table. The work definition table 110a of FIG. 7 contains the work definition items for all the stations, and has the fields of “Station Name,” “Station Address,” “Work definition Number,” “Object of Service,” “Feature of Service,” and “Destination of Service.” The information items in the entries in each row in the work definition table 110a are associated with each other, and constitute a work definition item.

In each work definition item, the name of the station which performs a work operation defined by the work definition item is set in the field “Station Name,” the address for uniquely identifying the station is set in the field “Station Address,” the identification number identifying the work definition item constituting the work definition set is set in the field “Work definition Number,” the name of the product as the object of the service is set in the field “Object of Service,” the feature of the service is set in the field “Feature of Service,” and the area in which the service is provided is set (i.e., the geographic area of the service is designated) in the field “Destination of Service.”

As described above, the work definitions for the respective stations are stored in the work definition DB 110. In this case, when the liaison between the stations is insufficient, the activities of different stations can overlap, or no station becomes responsible for some services. In the example of FIG. 7, the work definition for the Second Service Department and the work definition for the Customer-service Headquarters (both having the work definition number “1”) overlap in the maintenance service for the product Z. Since the work definition for each station is independently described by the station, the overlapping of the work definitions is inevitable.

### 2.6 Request Information

After the setting of the work definitions for all the stations is completed, work requests can be received, and request-information sets (request information) are produced and stored in the request DB 120.

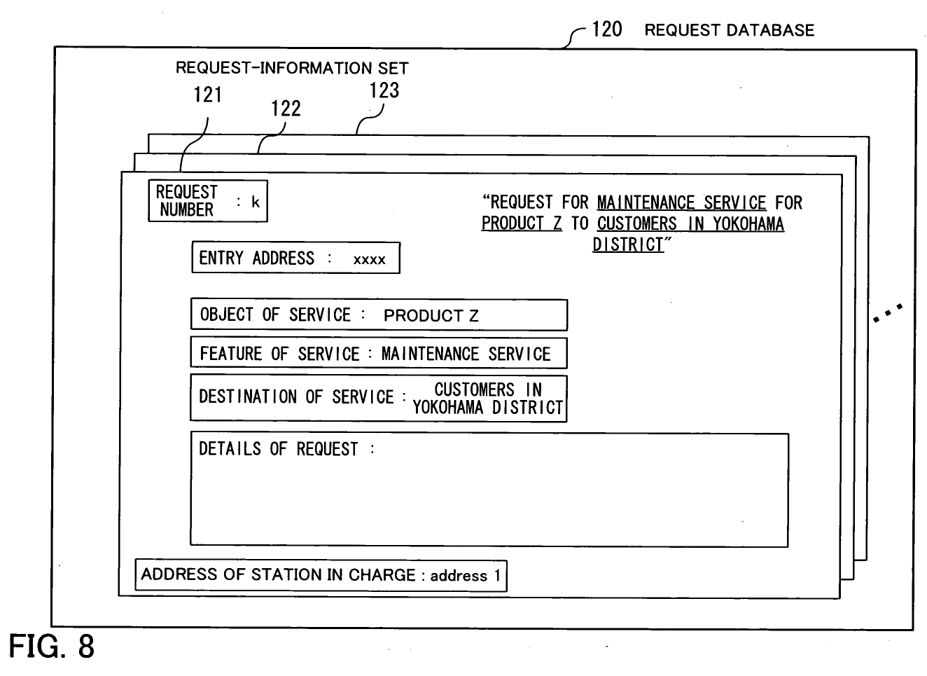

FIG. 8 is a diagram illustrating an example of a data structure of the request-information set. Each of the request-information sets 121, 122, 123, . . . contains the information items of “Request Number,” “Entry Address,” “Object of Service,” “Feature of Service,” “Destination of Service,” “Details of Request,” and “Address of Station in Charge.” These information items constitute a request-information set as a basic information set (slip) for use in requesting a work operation.

A number (request number) for uniquely identifying each work request, which is assigned by the request receiving unit 142, is set as the information item “Request Number.”

The address of the station which is first designated by a user (who makes the work request) as the destination of the work request in the structure of the organization is set as the information item “Entry Address.” When the user cannot find a specific station as the entry for the work request, the user sets the address of the root of (i.e., the station in the highest layer in) the structure of the organization as the entry address.

The name of the product for which the service is provided is set as the information item “Object of Service,” the feature of the service is set as the information item “Feature of Service,” and the name of the area in which the customers are located is set as the information item “Destination of Service.” In the example of FIG. 8, “Product Z” is set as the information item “Object of Service,” “Maintenance Service” is set as the information item “Feature of Service,” and “Customers in Yokohama District” is set as the information item “Destination of Service.” This indicates that provision of the Maintenance Service for the Product Z to the Customers in the Yokohama district is requested.

Details of the work request are set as the information item “Details of Request.” For example, the names of customers and/or information indicating whether or not the customers correspond to the “Specific Customers in Tokyo District” indicated as the information item “Destination of Service” in the work definition item for the “Customer-service Headquarters” may be set as the information item “Details of Request.”

The (station) address of the station to which the request-information set is to be delivered is set by the comparison unit 143 as the information item “Address of Station in Charge” when the work request is inputted into the work-flow management server 100. In addition, when a person belonging to the station to which the request-information set is delivered gives an instruction to forward the work request, the request handling unit 144 determines the destination of the work request to which the work request is forwarded, and updates the information item “Address of Station in Charge” with the address of the determined destination.

The request-information set as described above is delivered to a station the work definition for which corresponds to the request-information set. Then, information indicating whether or not the station to which the work request (request-information set) is forwarded has performed the requested work operation or forwarded the work request (request-information set) to another station is stored as a part of the request-processing histories in the request-processing-history DB 130.

### 2.7 Request-processing History

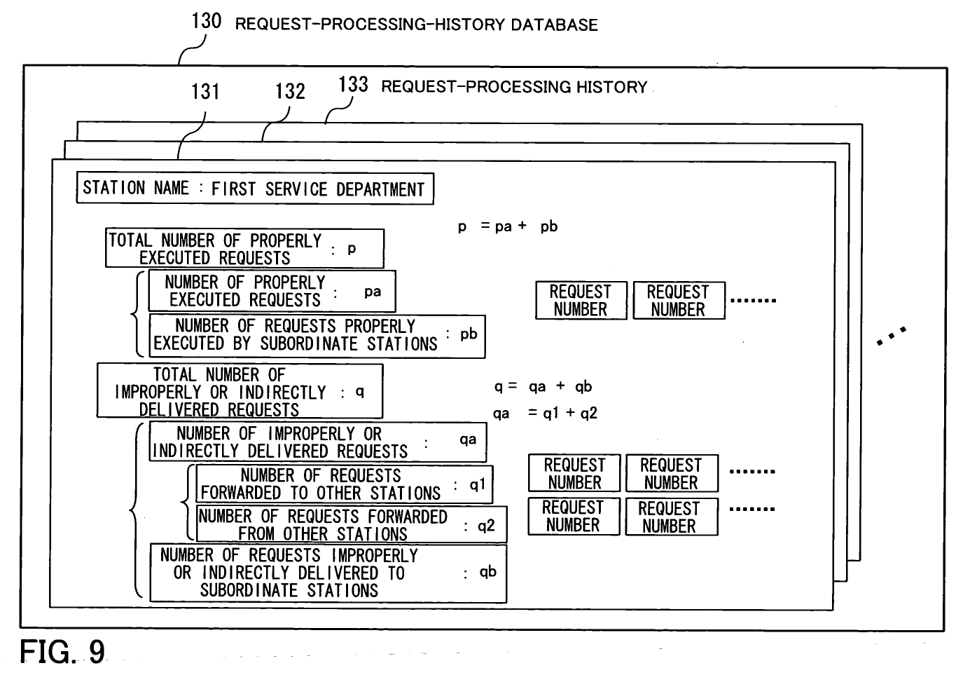

FIG. 9 is a diagram illustrating an example of a data structure of the request-processing histories. The request-processing-history DB 130 stores request-processing histories 131, 132, 133, . . . for the stations, respectively. Each of the request-processing histories 131, 132, 133, . . . contains the information items of “Station Name,” “Total Number of Properly Executed Requests,” and “Total Number of Improperly or Indirectly Delivered Requests.”

The name of a station corresponding to the request-processing history is set as the information item “Station Name.”

Each of the request-processing histories 131, 132, 133, . . . also contains the information items of “Number of Properly Executed Requests” and “Number of Requests Properly Executed by Subordinate Stations” under the information item “Total Number of Properly Executed Requests.” The number pa of work requests which are determined to have been properly executed by the station the name of which is indicated as the information item “Station Name” is set as the information item “Number of Properly Executed Requests,” the number pb of work requests which are determined to have been properly executed by one or more stations subordinate to the above station is set as the information item “Number of Requests Properly Executed by Subordinate Stations,” and the sum p of the numbers pa and pb is set as the information item “Total Number of Properly Executed Requests.” In addition, the request numbers of work requests determined to have been properly executed by the station the name of which is indicated as the information item “Station Name” is set are associated with the information item “Number of Properly Executed Requests.”

Each of the request-processing histories 131, 132, 133, . . . further contains the information items of “Number of Improperly or Indirectly Delivered Requests” and “Number of Requests Improperly or Indirectly Delivered to Subordinate Stations” under the information item “Total Number of Improperly or Indirectly Delivered Requests.” Furthermore, the information items of “Number of Requests Forwarded to Other Stations” and “Number of Requests Forwarded from Other Stations” are arranged under the information items “Number of Improperly or Indirectly Delivered Requests.” The request numbers of work requests which have been forwarded to other stations from the station the name of which is indicated as the information item “Station Name” is set are associated with the information item “Number of Requests Forwarded to Other Stations,” and the request numbers of work requests which have been forwarded from other stations to the station the name of which is indicated as the information item “Station Name” is set are associated with the information item “Number of Requests Forwarded from Other Stations.”

The number q1 of work requests which have been forwarded from the above station to other stations is set as the information item “Number of Requests Forwarded to Other Stations,” the number q2 of work requests which have been forwarded from other stations (e.g., from a default entry) to the above station (the name of which is indicated as the information item “Station Name”) is set as the information item “Number of Requests Forwarded from Other Stations,” and the sum qa of the numbers q1 and q2 (i.e., the number of work requests which have been improperly or indirectly delivered to the station the name of which is indicated as the information item “Station Name” is set) is set as the information item “Number of Improperly or Indirectly Delivered Requests.” In addition, the number qb of work requests which have been improperly or indirectly delivered to one or more stations subordinate to the station the name of which is indicated as the information item “Station Name” is set as the information item “Number of Requests Improperly or Indirectly Delivered to Subordinate Stations,” and the sum q of the numbers qa and qb is set as the information item “Total Number of Improperly or Indirectly Delivered Requests.”

As described above, a history of handling of work requests by each station is recorded in one of the request-processing histories 131, 132, 133, . . . corresponding to the station. In addition, the sum of the number of work requests which have been delivered to and executed by each station and the number of work requests which have been delivered to and executed by one or more stations subordinate to the above station is set as the total number of properly executed work requests corresponding to the station. This means that each station having one or more subordinate stations is responsible for operations performed by the one or more subordinate stations. Further, the sum of the number of work requests which have been improperly or indirectly delivered to each station and the number of work requests which have been improperly or indirectly delivered to one or more stations subordinate to the above station is set as the total number of improperly or indirectly delivered work requests corresponding to the station.

When a work request is passed to the request handling unit 144, the request handling unit 144 produces a record of handling of the work request as a part of the corresponding request-processing history, and sets the record in the request-processing-history table in the request-processing-history DB 130.

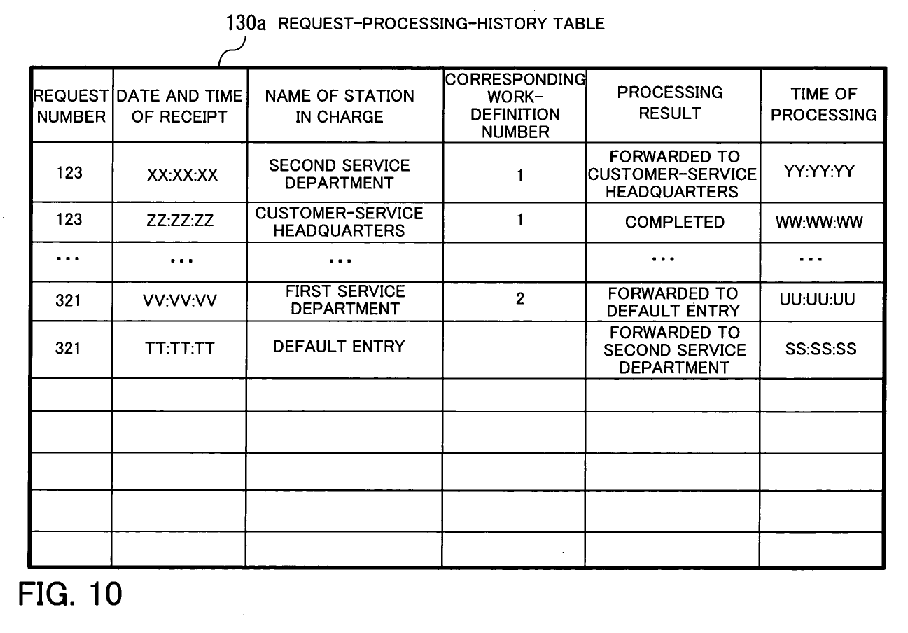

FIG. 10 is a flow diagram indicating an example of a data structure of the request-processing-history table. In the request-processing-history table 130a, the request-processing histories of all the stations are summarized, and the fields of “Request Number,” “Date and Time of Receipt,” “Name of Station in Charge,” “Corresponding Work definition Number,” “Processing Result,” and “Time of Processing” are arranged. The information items in the entries in each row in the request-processing-history table 130a are associated with each other, and constitute a request-processing history.

The request number which is set in the corresponding request-information set is set in the field “Request Number,” the date and time at which the corresponding request-information set is received is set in the field “Date and Time of Receipt,” the name of the station which is determined to be in charge of the work request is set in the field “Name of Station in Charge,” the work definition number of the work definition item on the basis of which the station indicated in the field “Name of Station in Charge” is determined to be in charge of the work request is set in the field “Corresponding Work definition Number,” the result of processing performed by the station indicated in the field “Name of Station in Charge” is set in the field “Processing Result,” and the time at which the work request is handled by the station indicated in the field “Name of Station in Charge” is set in the field “Corresponding Time of Processing.”

For example, the work request of the request number “123” has been received by the Second Service Department at the date and time “XX:XX:XX”. However, the Second Service Department has determined that the Second Service Department cannot properly execute the work request “123,” so that the work request has been forwarded to the Customer-service Headquarters at the date and time “YY:YY:YY.” Then, the work request “123” has been received by the Customer-service Headquarters at the date and time “ZZ:ZZ:ZZ,” and executed according to the corresponding request-information set at the date and time “WW:WW:WW.”

On the other hand, the work request “321” has first been received by the First Service Department. However, the First Service Department has determined that the First Service Department cannot properly execute the work request “321,” so that the work request has been forwarded to a default entry. Thereafter, the default entry has searched for an appropriate station in charge of executing the work request, and forwarded the work request “321” to the Second Service Department.

### 2.8 Forwarding of Request

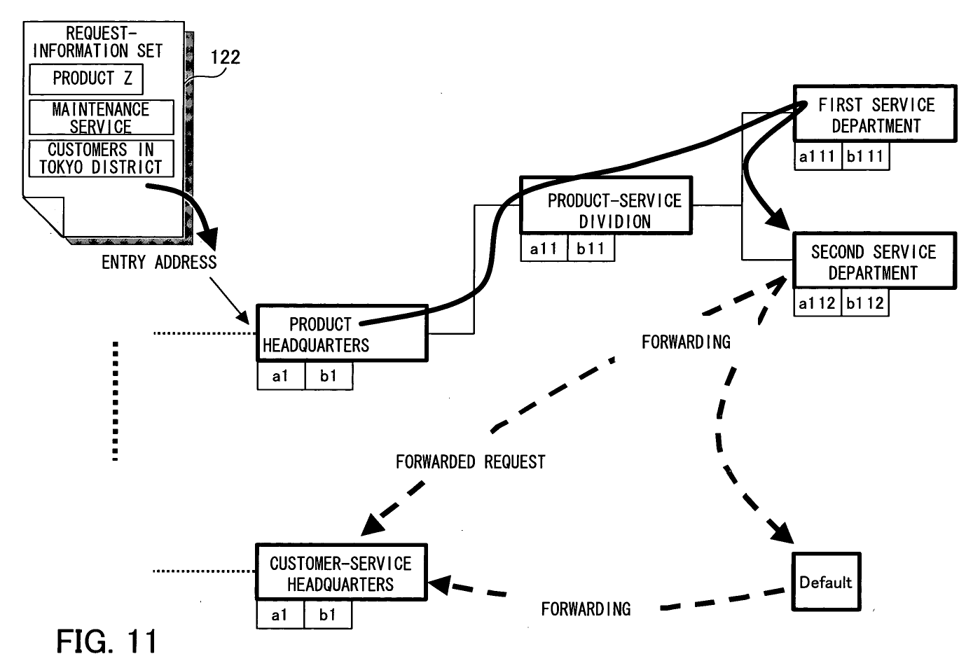

FIG. 11 is a schematic diagram indicating an example of forwarding of a work request (request-information set). The work request (request-information set) 122 indicated in FIG. 11 demands for the Maintenance Service for the Product Z to the Customers in the Tokyo district, and the address of the Product Headquarters is designated as the entry address. Therefore, the comparison unit 143 searches for a station in charge of executing the work request.

In the example of FIG. 11, the comparison unit 143 compares the request-information set 122 with the work definition “a1” for the Product Headquarters, and determines that the work definition “a1” for the Product Headquarters does not match the request-information set 122, so that the comparison unit 143 refers to the work definition for the Product-Service Division, which is immediately subordinate to the Product Headquarters. Then, the comparison unit 143 compares the request-information set 122 with the work definition “a11” for the Product-Service Division, and determines that the work definition “a11” for the Product-Service Division does not match the request-information set 122, so that the comparison unit 143 further refers to the work definition for the First Service Department, which is immediately subordinate to the Product-Service Division. Then, the comparison unit 143 compares the request-information set 122 with the work definition “a111” for the First Service Department, and determines that the work definition “a111” for the First Service Department does not match the request-information set 122. Since no station subordinate to the First Service Department exists, the comparison unit 143 refers to the work definition for the Second Service Department, which is also immediately subordinate to the Product-Service Division. Then, the comparison unit 143 compares the request-information set 122 with the work definition “a112” for the Second Service Department, and determines that the work definition “a112” for the Second Service Department matches the request-information set 122, so that the Second Service Department is determined to receive the work request 122.

Next, a person belonging to the Second Service Department refers to details of the work request 122 by using a client. In the example of FIG. 11, the person belonging to the Second Service Department determines that the work operation requested by the work request 122 is not to be performed by the Second Service Department. In this case, when the person belonging to the Second Service Department knows a station which should perform the work operation requested by the work request 122, the person belonging to the Second Service Department gives an instruction to forward the work request 122 to the station which should perform the work operation. In the example of FIG. 11, the station is the Customer-service Headquarters. Then, the request handling unit 144 receives the instruction, and forwards the work request 122 to the Customer-service Headquarters.

When the person belonging to the Second Service Department does not know the station which should perform the work operation requested by the work request 122, the person belonging to the Second Service Department gives no instruction, so that the request handling unit 144 forwards the work request 122 to the default entry, which is a station arranged to receive any unexecuted work requests.

On receipt of the work request 122, a person belonging to the default entry refers to the details of the work request 122 by using a client, searches the organization for an appropriate station, and gives an instruction to forward the work request 122 to the appropriate station. The instruction is sent to the request handling unit 144, so that the request handling unit 144 forwards the work request 122 to the station designated in the instruction.

In the case where the comparison unit 143 cannot find a station which can execute the work request 122, even by reference to the work definitions for all the stations after receipt of the work request 122, the comparison unit 143 forwards the work request 122 to the default entry. Thereafter, a person belonging to the default entry determines the destination of the work request.

### 2.9 Processing Sequences

Hereinbelow, sequences of processing for forwarding a work request and producing a request-processing history are explained.

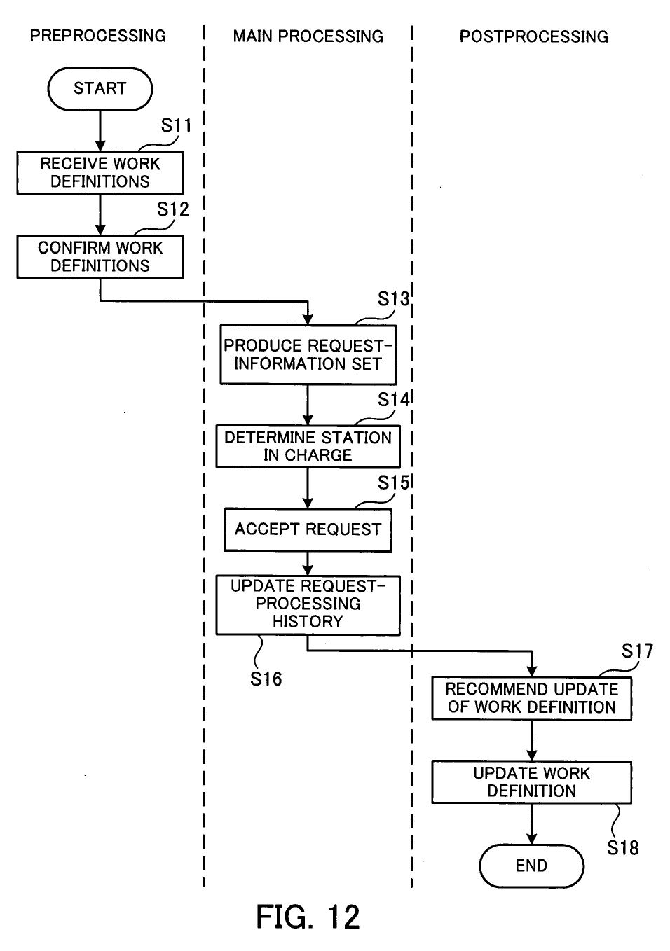

FIG. 12 is a flow diagram indicating a sequence of processing according to the first embodiment of the present invention. The processing according to the first embodiment includes preprocessing (steps S11 and S12), main processing (steps S13 to S16), and postprocessing (steps S17 and S18). In the preprocessing, initial data necessary for execution is prepared. Specifically, in the preprocessing, the work-flow management server 100 receives work definitions for the stations, and produces the work definition table on the basis of the work definitions for the stations. In the main processing, the work-flow management server 100 generates a concrete request-information set for each work request, transfers the request-information set within the tree structure of the organization, confirms acceptance of the work request by a station the work definition which matches the work request, and reflects the result of processing of the work request in a request-processing history. In the postprocessing, every time a work request is executed, a request-processing history is referred to, a station for which a work definition is to be updated is determined, a recommendation to update the work definition is outputted, and the work definition is updated. The processing indicated in FIG. 12 is explained below step by step.

<Step S1> Persons belonging to the respective stations designate a client, access the work-flow management server 100, and inputs information indicating the range of a work which can be provided by the station. Then, the definition control unit 141 in the work-flow management server 100 produces a work definition for each station according to the inputted information, and stores the work definition in the work definition DB 110.

<Step S12> The definition control unit 141 confirms whether or not the work definitions for the stations overlap. When yes is determined, the definition control unit 141 gives a recommendation to correct the work definition for the station, to a person belonging to each station for which the work definition is to be corrected.

<Step S13> Each person in charge (e.g., salespersons) accesses the work-flow management server 100 by using a client, and manually inputs information on a customer's request for a work. Then, the request receiving unit 142 in the work-flow management server 100 produces a request-information set on the basis of the information on the customer's request, and passes the request-information set to the comparison unit 143.

<Step S14> The comparison unit 143 receives the request-information set produced in step S13, compares the request-information set with work definitions registered in the work definition DB 110, and determines one of the work definitions corresponding to the request-information set. Then, the comparison unit 143 sets a station having the work definition corresponding to the request-information set as the station in charge, and passes the request-information set to the request handling unit 144. The request handling unit 144 stores the request-information set in the request DB 120. In addition, when the work-flow management server 100 receives from the station in charge a request for reference to a request-information set, the request output unit 145 sends the request-information set to a client used by a person belonging to the station.

<Step S15> When the work-flow management server 100 receives from a person belonging to the station in charge an instruction to forward a request-information set, the request handling unit 144 forwards the request-information set to another station. In addition, when the work-flow management server 100 receives information indicating acceptance of a work request from a station in charge or a station to which the request-information set is forwarded, the processing for forwarding the request-information set is completed.

<Step S16> The request handling unit 144 updates one or more of the request-processing histories in the request-processing-history DB 130, with a record of processing of the work request performed after the work request is received until acceptance of the work request by a station is confirmed.

<Step S17> The definition-correction processing unit 146 refers to the request-processing-history DB 130, and searches for a station for which the aforementioned statistic obtained on the basis of the number of work requests which have been rejected by the station (i.e., the number of work requests which have been forwarded to other stations after the station has been determined to be in charge of executing the work requests) is greater than a predetermined number. When such a station is detected, the definition-correction processing unit 146 gives a recommendation to correct the work definition for the station to a person belonging to the detected station.

<Step S18> When the person belonging to the station detected in step S17 manually inputs through a client an instruction to update the work definition for the station, and the work-flow management server 100 receives the instruction, the definition control unit 141 updates the work definition.

Next, the processing in each part of the sequence of FIG. 12 is explained in detail below.

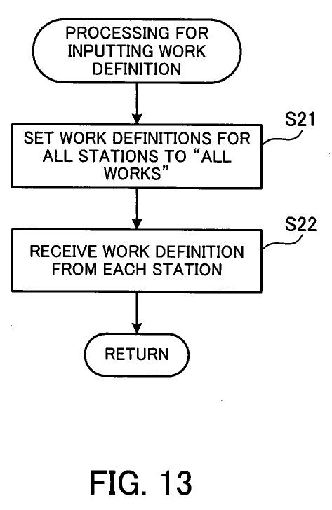

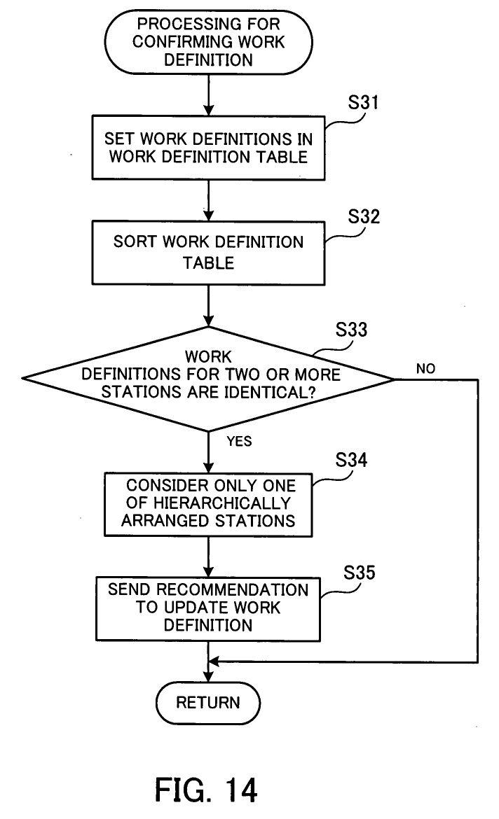

FIG. 13 is a flow diagram indicating a sequence of processing for inputting the work definitions. The processing indicated in FIG. 13 is explained below step by step.

<Step S21> The definition control unit 141 initializes the work definitions in the work definition DB 110. Specifically, the definition control unit 141 sets “All” in each of the items “Object of Service,” “Feature of Service,” and “Destination of Service” in the work definitions for all the stations, so that each station becomes in charge of all works.

<Step S22> The definition control unit 141 receives information on the object of a service provided by each station, the feature of the service, and the destination of the service, from a person belonging to the station through one of the clients 21, 22, 23, . . . , and updates with the received information the work definition for the station which is stored in the work definition DB 110.

FIG. 14 is a flow diagram indicating a sequence of processing for confirming the work definitions. The processing indicated in FIG. 14 is explained below step by step.

<Step S31> The definition control unit 141 sets for each station the information on the station name, the station address, the work definition number, the object of the service, the feature of the service, and the destination of the service in the work definition table by reference to the work definition for the station. The correspondences between the station names and the station addresses are registered in advance in the definition control unit 141, so that the definition control unit 141 can determine each station address on the basis of the corresponding station name.

<Step S32> The definition control unit 141 sorts the work definition items set in the work definition table by using as keys the object of the service, the feature of the service, and the destination of the service so as to closely arrange similar work definition items and facilitate detection of overlap of work definitions or omission of a work.

<Step S33> The definition control unit 141 determines whether or not work definitions for two or more stations are identical in all of the object of the service, the feature of the service, and the destination of the service. When yes is determined, the operation goes to step S34. When no is determined, the processing of FIG. 14 is completed.

<Step S34> When work definitions for a plurality of hierarchically arranged stations in the tree structure are identical in all of the object of the service, the feature of the service, and the destination of the service, the definition control unit 141 takes only one of the hierarchically arranged stations into consideration (i.e., excludes the other stations in the vertical array from consideration). This is because overlapping of work definitions is allowed when a work definition for an upper-layer station covers one or more work definitions for one or more subordinate stations.

<Step S35> The definition control unit 141 sends to the one of the plurality of stations (which is not excluded in step S34) a recommendation to update the work definition for the station by e-mail, and thereafter the processing of FIG. 14 is completed. The e-mail address of a person belonging to each station is registered in advance in the definition control unit 141.

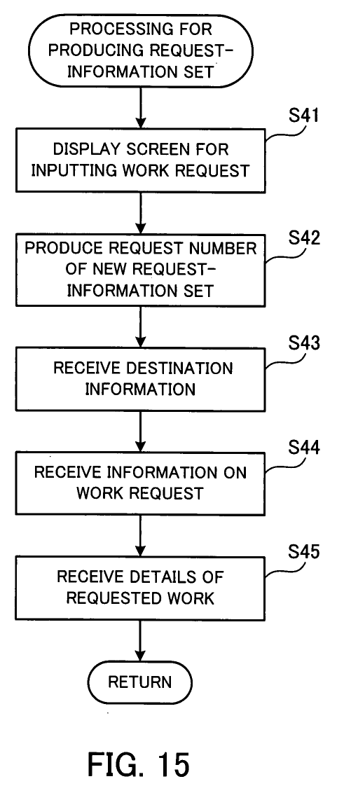

FIG. 15 is a flow diagram indicating a sequence of processing for producing request information. The processing indicated in FIG. 15 is explained below step by step.

<Step S41> The request receiving unit 142 makes a client (used by a person in charge, e.g., a salesperson, who is asked by a customer to provide a work) display a screen for inputting a work request.

<Step S42> The request receiving unit 142 produces the request number of a newly produced request-information set by incrementing by one the request number of a preceding request-information set (produced for a precedingly received work request), and sets the produced request number as the information item “Request Number” in the newly produced request-information set. The request number of the precedingly produced request information is stored in a memory in the request receiving unit 142.

<Step S43> The request receiving unit 142 receives from the client information on a station to which the request is to be first delivered. Specifically, the request receiving unit 142 acquires the work definition table 110a from the work definition DB 110, and makes the client display the work definition table 110a. The person in charge browses the work definitions displayed on the screen of the client, and selects a station as a destination of the work request. The request receiving unit 142 acquires the station address of the selected station from the work definition table 110a, and sets the acquired station address as the entry address in the request-information set. When the station as the destination of the work request is not designated by the person in charge, the request receiving unit 142 sets as the entry address the address of the station at the top of the tree structure of the organization.

<Step S44> The request receiving unit 142 receives from the client the object of the service, the feature of the service, and the destination of the service of a work request. For example, when one of the work definition items in the work definition table 110a displayed on the client is selected, the request receiving unit 142 determines that the object of the service, the feature of the service, and the destination of the service of the selected work definition item to constitute the work request. Then, the request receiving unit 142 sets the information items in the request-information set in accordance with the information on the work request designated by the client.

<Step S45> The request receiving unit 142 receives from the client information on details of the requested work, and sets the received information as the information item “Details of Request” in the request-information set.

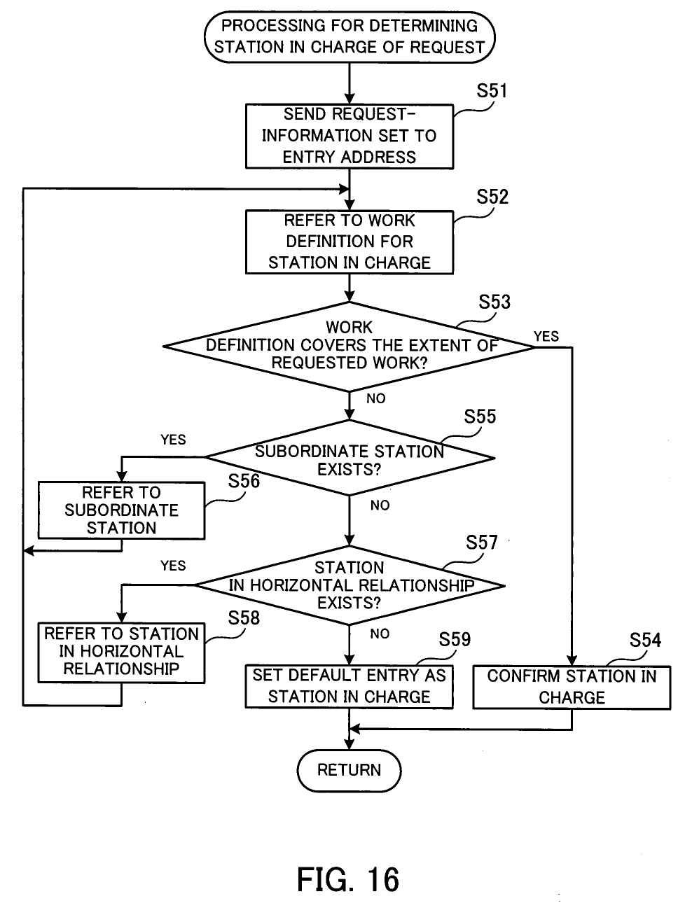

FIG. 16 is a flow diagram indicating a sequence of processing for determining a station in charge of a work request. The processing indicated in FIG. 16 is explained below step by step.

<Step S51> The comparison unit 143 sends the request-information set to the entry address indicated in the request-information set. Specifically, the comparison unit 143 sets the entry address as the information item “Address of Station in Charge” in the request-information set.

<Step S52> The comparison unit 143 acquires from the work definition DB 110 the work definition for the station in charge which is indicated by the information item “Address of Station in Charge,” and refers to the acquired work definition.

<Step S53> The comparison unit 143 compares the work definition for the station in charge with the information in the request-information set. Specifically, the comparison unit 143 compares the work definition and the request-information set with respect to the object of the service, the feature of the service, and the destination of the service, and determines whether or not the work definition covers the extent of the work indicated in the request-information set. When the work definition matches the request-information set, the operation goes to step S54. When the work definition does not match the request-information set, the operation goes to step S55.

<Step S54> The comparison unit 143 confirms the current settings of the station in charge, and passes the request-information set to the request handling unit 144. Thereafter, the processing of FIG. 16 is completed.

<Step S55> The comparison unit 143 determines whether or not one or more subordinate stations exist. When yes is determined, the operation goes to step S56. When no is determined, the operation goes to step S57.

<Step S56> The comparison unit 143 selects one of the one or more stations subordinate to the current station in charge, determines the selected station as a new station in charge, and sets the station address of the new station in charge as the information item “Address of Station in Charge” in the request-information set. Thereafter, the operation goes to step S52.

<Step S57> The comparison unit 143 determines whether or not one or more stations having a horizontal relationship with the current station in charge. When yes is determined, the comparison unit 143 selects one of the one or more stations. When no is determined, the comparison unit 143 determines whether or not one or more stations having a horizontal relationship with a station immediately superior to the current station in charge exist. Thereafter, the comparison unit 143 traces upward the tree structure in a similar manner until one or more stations having a horizontal relationship with a station superior to the current station in charge is found. When the one or more stations having a horizontal relationship with a station superior to the current station in charge are found, the operation goes to step S58. In the case where no station having a horizontal relationship with a station superior to the current station in charge is found, the operation goes to step S52.

<Step S58> The comparison unit 143 selects one of the one or more stations found in step S57, determines the selected station to be a new station in charge, and sets the address of the new station in charge as the information item “Address of Station in Charge” in the request-information set. Then, the comparison unit 143 passes the request-information set to the request handling unit 144. Thereafter, the operation goes to step S52.

<Step S59> The comparison unit 143 sets the default entry as the station in charge. That is, the comparison unit 143 sets an address which is assigned in advance to the default entry, as the information item “Address of Station in Charge” in the request-information set. Then, the comparison unit 143 passes the request-information set to the request handling unit 144. Thereafter, the processing of FIG. 16 is completed.

As described above, the station which should execute the work request is searched for by tracing the organization downward from the station at the entry address. During the search, the request-information set is compared with the work definition for each station, and a determination whether or not the request-information set and the work definition for each station are identical in the object of the service, the feature of the service, and the destination of the service is made. When a station having a work definition which matches the request-information set is found, the station is determined to be the station in charge. When a work definition for each station does not match the request-information set, the work definition for an immediately subordinate station is checked. When the search reaches a bottom-layer station and the work definition for the bottom-layer station does not match the request-information set, one or more stations having a horizontal relationship with one of the already checked stations are searched. In the case where no station in the organization has a work definition which matches the request-information set, the default entry is. set as the station in charge.

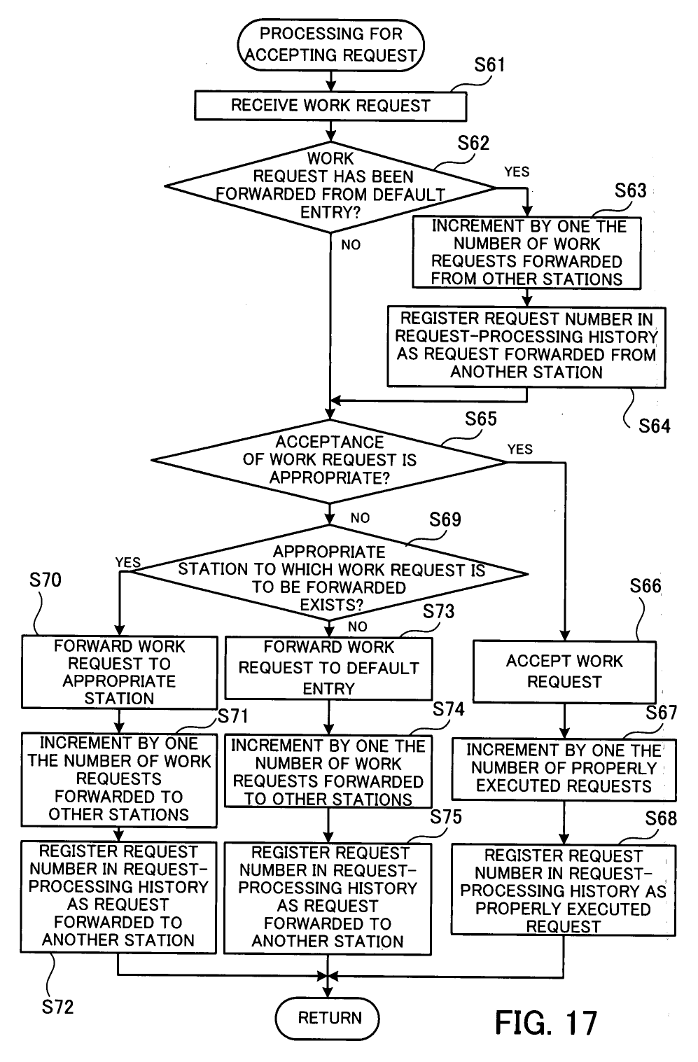

FIG. 17 is a flow diagram indicating a sequence of processing for accepting a work request. The processing indicated in FIG. 17 is explained below step by step.

<Step S61> The request handling unit 144 receives a work request (request-information set) from the comparison unit 143, and stores the request-information set in the request DB 120. Then, the request handling unit 144 additionally registers a request-processing history of the work request (i.e., a record of processing of the work request indicated by the received request-information set) in the request-processing-history table 130a in the request-processing-history DB 130. Specifically, in the added request-processing history in the request-processing-history table 130a, the request number of the request-information set is set in the field “Request Number,” the date and time at which the request-information set is received are set in the field “Date and Time of Receipt,” and the name of the station the address of which is indicated in the information item “Address of Station in Charge” in the request-information set is set in the field “Station Name.” In addition, the request handling unit 144 acquires from the comparison unit 143 the work definition number of a work definition item on the basis of which the comparison unit 143 determines the station in charge of executing a work request indicated by the request-information set, and sets the work definition number in the field “Corresponding Work definition Number” in the added request-processing history in the request-processing-history table 130a. At this time, the fields “Processing Result” and “Time of Processing” in the above record are blank.

Further, when the work-flow management server 100 receives a request for reference to a request-information set from a client used by a person belonging to a station, the request output unit 145 sends the request-information set to the client. Specifically, the request for reference contains a name of a station, and the request handling unit 144 searches the request DB 120 for a request-information set on the basis of the name of the station contained in the request for reference, where the address of the station the name of which is indicated in the request for reference is indicated as the information item “Address of Station in Charge” in the request-information set. Then, the request output unit 145 sends the detected request-information set to the client.

<Step S62> The request handling unit 144 determines whether or not the request-information set which is sent in step S61 in response to the request for reference corresponds to a work request which has been forwarded from the default entry. When yes is determined, the operation goes to step S63. When no is determined, the operation goes to step S65.

<Step S63> The request handling unit 144 accesses the request-processing history of the station in charge, stored in the request-processing-history DB 130, and increments by one the number (q2) of work requests which have been forwarded from other stations to the current station in charge, which is indicated as the information item “Number of Requests Forwarded from Other Stations” in the request-processing history of the station in charge.

<Step S64> The request handling unit 144 accesses the request-processing history of the station in charge, stored in the request-processing-history DB 130, and registers the request number of the request-information set in association with the information item “Number of Requests Forwarded from Other Stations.”

<Step S65> When a person belonging to the station in charge inputs through a client information indicating whether or not the work request indicated by the request-information set is properly accepted, the request handling unit 144 receives the information. Specifically, the person belonging to the station in charge makes the client display the information contained in the request-information set, and determines whether or not the work request indicated by the request-information set is to be accepted by the station in charge, on the basis of the information in the request-information set. Then, the person belonging to the station in charge inputs the result of the determination into the client, so that the result of the determination is sent from the client to the work-flow management server 100.

The request handling unit 144 recognizes whether or not the work request indicated by the request-information set is accepted by the station in charge. When the work request indicated by the request-information set is accepted by the station in charge, the operation goes to step S66. When the work request indicated by the request-information set is rejected by the station in charge, the operation goes to step S69.

<Step S66> The request handling unit 144 confirms the acceptance, by the station in charge, of the work request indicated by the request-information set. For example, the request handling unit 144 sets a flag indicating the acceptance in the corresponding request-information set stored in the request DB 120.

<Step S67> The request handling unit 144 accesses the request-processing history of the station in charge, stored in the request-processing-history DB 130, and increments by one the number (pa) of requests which have properly executed by the current station in charge, which is indicated as the information item “Number of Requests Forwarded from Other Stations” in the request-processing history of the station in charge.

<Step S68> The request handling unit 144 accesses the request-processing history of the station in charge, stored in the request-processing-history DB 130, and registers the request number of the request-information set in association with the information item “Number of Requests Forwarded from Other Stations” in the request-processing history of the station in charge. Thereafter, the processing of FIG. 17 is completed.

<Step S69> When the person belonging to the station in charge inputs through a client information indicating whether or not an appropriate station to which the work request is to be forwarded exists, the request handling unit 144 receives the information. Specifically, when the person belonging to the station in charge determines that the work request should not be accepted by the station to which the person belongs, and knows the appropriate station to which the work request is to be forwarded, the person belonging to the station in charge inputs into the client the name of the appropriate station to which the work request is to be forwarded, so that the inputted name of the appropriate station is sent from the client to the work-flow management server 100.

The request handling unit 144 can recognize the appropriate station to which the work request is to be forwarded, on the basis of the name of the station sent from the client. When the appropriate station to which the work request is to be forwarded is designated by the person belonging to the station in charge, the operation goes to step S70. When no appropriate station to which the work request is to be forwarded is designated, the operation goes to step S73.

<Step S70> The request handling unit 144 forwards the work request to the designated station. Specifically, the request handling unit 144 sets the address of the designated station as the information item “Address of Station in Charge” in the request-information set.

<Step S71> The request handling unit 144 accesses the request-processing history of the station from which the work request is forwarded, stored in the request-processing-history DB 130, and increments by one the number (q1) of work requests which have been forwarded to other stations, which is indicated as the information item “Number of Requests Forwarded to Other Stations” in the request-processing history of the station from which the work request is forwarded.

<Step S72> The request handling unit 144 accesses the request-processing history of the station from which the work request is forwarded, stored in the request-processing-history DB 130, and registers the request number of the request-information set in association with the information item “Number of Requests Forwarded to Other Stations.” Thereafter, the processing of FIG. 17 is completed.

<Step S73> The request handling unit 144 forwards the work request (request-information set) to the default entry. Specifically, the request handling unit 144 sets the address of the default entry as the information item “Address of Station in Charge” in the request-information set.

<Step S74> The request handling unit 144 accesses the request-processing history of the station from which the work request is forwarded, stored in the request-processing-history DB 130, and increments by one the number (q1) of work requests which have been forwarded to other stations, which is indicated as the information item “Number of Requests Forwarded to Other Stations” in the request-processing history of the station from which the work request is forwarded.

<Step S75> The request handling unit 144 accesses the request-processing history of the station from which the work request is forwarded, stored in the request-processing-history DB 130, and registers the request number of the request-information set in association with the number (q1) of work requests which have been forwarded to other stations. Thereafter, the processing of FIG. 17 is completed.

As described above, each work request is accepted by a station in charge or forwarded to another station. Specifically, when a work request is forwarded from the default entry to a station, the number (q2) of work requests which have been forwarded to the station in charge is incremented. When a work request is rejected by a first station and a person belonging to the first station knows a second station to which the work request is to be forwarded, the work request is forwarded to the second station, and the number (q1) of work requests which have been forwarded from the first station to other stations is incremented. When the person belonging to the first station knows no station to which the work request is to be forwarded, the work request is forwarded to the default entry, and the number (q1) of work requests which have been forwarded from the first station to other stations is incremented.

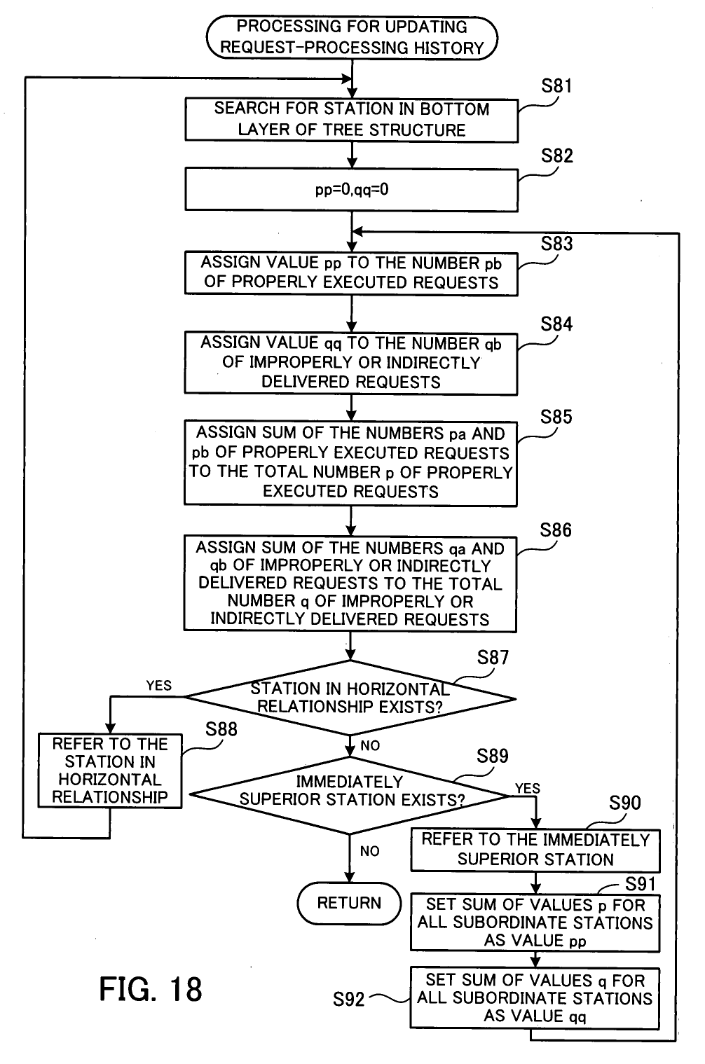

FIG. 18 is a flow diagram indicating a sequence of processing for updating the request-processing history. The processing of FIG. 18 is performed every time a work request is accepted or forwarded. The processing indicated in FIG. 18 is explained below step by step.

<Step S81> The request handling unit 144 searches for a station in a bottom layer of the tree structure, and refers to the request-processing history of the station. In the explanations of the sequence of FIG. 18, the station in which the request-processing history is currently looked up is referred to as the station of interest.

<Step S82> The request handling unit 144 sets zero to the variables “pp” and “qq” for the request-processing history of the station of interest.

<Step S83> The request handling unit 144 assigns the value of the variable “pp” to the information item “Number of Requests Properly Executed by Subordinate Stations” in the request-processing history (pb<-pp).

<Step S84> The request handling unit 144 assigns the value of the variable “qq” to the information item “Number of Requests Improperly or Indirectly Delivered to Subordinate Stations” in the request-processing history (qb<-qq).

<Step S85> The request handling unit 144 obtains the sum (p) of the value (pa) of the information item “Number of Properly Executed Requests” and the value (pb) of the information item “Number of Requests Properly Executed by Subordinate Stations” in the request-processing history, and assigns the sum (p) to the information item “Total Number of Properly Executed Requests” in the request-processing history (p<-pa+pb).

<Step S86> The request handling unit 144 obtains the sum (q) of the value (qa) of the information item “Number of Requests Improperly or Indirectly Delivered” and the value (qb) of the information item “Number of Requests Improperly or Indirectly Delivered to Subordinate Stations” in the request-processing history, and assigns the sum (q) to the information item “Total Number of Improperly or Indirectly Delivered Requests” in the request-processing history (q<-qa+qb), where the value (qa) of the information item “Number of Requests Improperly or Indirectly Delivered” is the sum of the value (q1) of the information item “Number of Requests Forwarded to Other Stations” and the value (q2) of the information item “Number of Requests Forwarded from Other Stations” (qa=q1+q2).

<Step S87> The request handling unit 144 determines whether or not a station which has a horizontal relationship with the station of interest and has not yet been executed in the sequence of FIG. 18 exists. When yes is determined, the operation goes to step S88. When no is determined, the operation goes to step S89.

<Step S88> The request handling unit 144 refers to the request-processing history of the station detected in step S87. Thereafter, the operation goes to step S81.

<Step S89> The request handling unit 144 determines whether or not a station immediately superior to the station of interest exists. When yes is determined, the operation goes to step S90. When no is determined, the processing indicated in FIG. 18 is completed.

<Step S90> The request handling unit 144 refers to the request-processing history of the station detected in step S89.

<Step S91> The request handling unit 144 acquires the values (p) of the information item “Number of Properly Executed Requests” for all stations subordinate to the station detected in step S89, and sets the sum of the acquired values (p) as the variable pp.

<Step S92> The request handling unit 144 acquires the values (q) of the information item “Number of Requests Improperly or Indirectly Delivered” for all stations subordinate to the station detected in step S89, and sets the sum of the acquired values (q) as the variable qq. Thereafter, the operation goes to step S83.

As described above, the request-processing histories of all the stations are updated. Specifically, a station in a bottom layer of the organization is searched for, and the values of the information items “Number of Properly Executed Requests” and “Number of Requests Improperly or Indirectly Delivered” are set. Then, stations superior to the station in the bottom layer are successively searched for, the value of the information item “Total Number of Properly Executed Requests” in the station immediately subordinate to each station detected by the search is added to the value of the information item “Total Number of Properly Executed Requests” in the station detected by the search, and the value of the information item “Total Number of Improperly or Indirectly Delivered Requests” in the station immediately subordinate to each station detected by the search is added to the value of the information item “Total Number of Improperly or Indirectly Delivered Requests” in the station detected by the search. That is, the value of the information item “Total Number of Properly Executed Requests” in each station finally includes the numbers of requests properly executed by one or more stations subordinate to the station detected by the search. Therefore, each station is responsible for handling or execution of work requests properly executed by, or improperly or indirectly delivered to one or more stations subordinate to the station. The above operations are performed on all the stations in the organization.

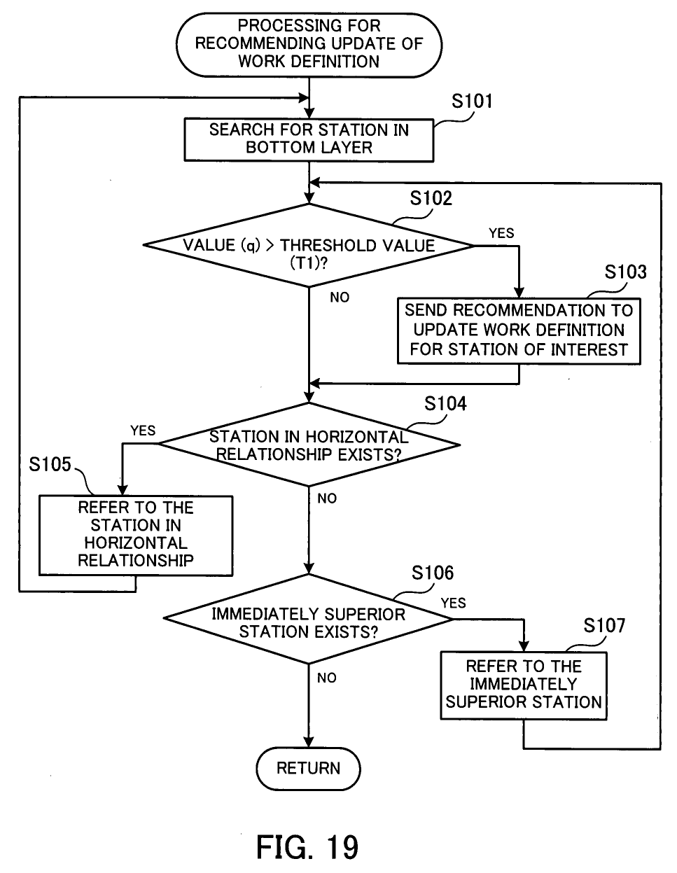

FIG. 19 is a flow diagram indicating a sequence of processing for recommending update of work definitions. The processing indicated in FIG. 19 is explained below step by step.

<Step S101> The definition-correction processing unit 146 searches for a station in a bottom layer which is subordinate to a station of interest, and refers to the request-processing history of the station detected by the search. In the following steps in FIG. 19, the station in which the request-processing history is currently looked up is referred to as the station of interest.

<Step S102> The definition-correction processing unit 146 determines whether or not the value (q) of the information item “Total Number of Improperly or Indirectly Delivered Requests” for the station of interest is greater than a threshold value (T1), which is preset. When yes is determined, the operation goes to step S103. When no is determined, the operation goes to step S104.

<Step S103> The definition-correction processing unit 146 sends to the station of interest a recommendation to update the work definition for the station. Specifically, the definition-correction processing unit 146 sends a message of recommending update of the work definition for the station of interest, to the station of interest by e-mail.

<Step S104> The definition-correction processing unit 146 determines whether or not a station which has a horizontal relationship with the station of interest and has not yet been executed in the sequence of FIG. 19 exists. When yes is determined, the operation goes to step S105. When no is determined, the operation goes to step S106.

<Step S105> The definition-correction processing unit 146 determines the station detected in step S104 to be the station of interest. Thereafter, the operation goes to step S101.

<Step S106> The definition-correction processing unit 146 determines whether or not a station immediately superior to the station of interest exists. When yes is determined, the operation goes to step S107. When no is determined, the processing indicated in FIG. 19 is completed.

<Step S107> The definition-correction processing unit 146 determines the station detected in step S106 to be the station of interest. Thereafter, the operation goes to step S102.

As described above, a station having the value (q) of the information item “Total Number of Improperly or Indirectly Delivered Requests” greater than the threshold value (T1) can be detected by reference to the request-processing histories and the request-processing-history table. When such a station is detected, it is determined that the work definition for the detected station is not appropriately described, so that a notice for recommending update of the work definition is automatically sent to a person belonging to the station. The above operations are performed so as to search all the stations in the organization.

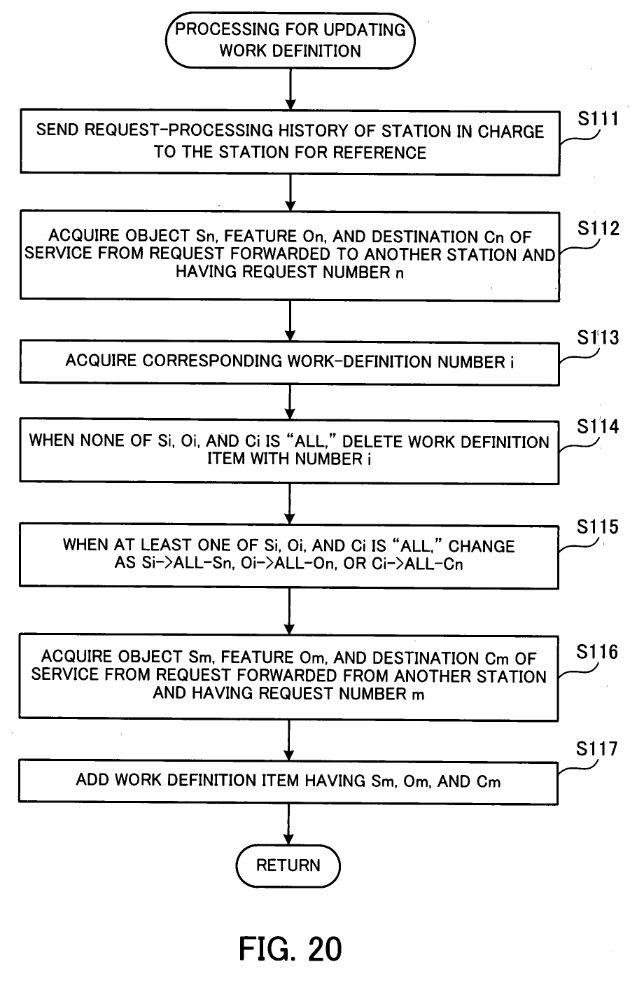

FIG. 20 is a flow diagram indicating a sequence of processing for updating work definitions. The processing indicated in FIG. 20 is explained below step by step.

<Step S111> When a person in charge belonging to a station sends to the work-flow management server 100 a request for reference to the request-processing history of the station, and the name of the station is designated in the request, the work-flow management server 100 receives the request for reference, and the definition control unit 141 sends the request-processing history to the client, so that the request-processing history is displayed on the client, and the person in charge refers to the request-processing history. Then, the person in charge designates a work request to be used in update of the work definition, and inputs into the client an instruction to automatically update the work definition, where the designated work request is one of work requests which have been forwarded from or to the station. Thus, a request for update of the work definition in which the work request to be used in the update of the work definition is designated is sent to the work-flow management server 100, and the following processing is performed.

<Step S112> When the work request designated in the request for the update of the work definition is a work request which has been forwarded to another station, the definition control unit 141 acquires the request number n of the work request, where n is a natural number. Next, the definition control unit 141 refers to the request-processing history having the request number n in the request-processing-history table 130a. Then, the definition control unit 141 acquires the object of the service Sn, the feature of the service On, and the destination of the service Cn from the request-information set corresponding to the request number n.

<Step S113> The definition control unit 141 acquires the work definition number i from the request-processing history corresponding to the request number n, where i is a natural number.

<Step S114> The definition control unit 141 refers to the work definition for the station to which the person in charge belongs to (which is determined on the basis of the name of the station designated in step S111), and acquires the work definition item having the work definition number i. Next, the definition control unit 141 refers to the object of the service Si, the feature of the service Oi, and the destination of the service Ci in the request-processing history. When none of the object of the service Si, the feature of the service Oi, and the destination of the service Ci is “All,” the definition control unit 141 deletes the work definition item corresponding to the work definition number i.

<Step S115> When at least one of the object of the service Si, the feature of the service Oi, and the destination of the service Ci is “All,” the definition control unit 141 makes setting of the information items “Object of Service,” “Feature of Service,” and “Destination of Service” so as to exclude the object of the service Sn, the feature of the service On, and the destination of the service Cn from the work definition corresponding to the request number n. Specifically, the definition control unit 141 makes setting of the information items “Object of Service,” “Feature of Service,” and “Destination of Service” so that one of the object of the service Si, the feature of the service Oi, and the destination of the service Ci which is “All” is changed to the corresponding one of Si=All-Sn, Oi=All-On, and Ci=All-Cn, where “All-Sn” means all but Sn, “All-On” means all but On, “All-Cn” means all but Cn.

<Step S116> When the work request designated in the request for the update of the work definition is a work request which has been forwarded from another station, the definition control unit 141 acquires the request number m of the work request, where m is a natural number. Next, the definition control unit 141 refers to the request-processing history having the request number m in the request-processing-history table 130a. Then, the definition control unit 141 acquires the object of the service Sm, the feature of the service Om, and the destination of the service Cm from the request-processing history corresponding to the request number m.

<Step S117> The definition control unit 141 adds a work definition item to the work definition for the station to which the person in charge belongs to (which is determined to on the basis of the name of the station designated in step S111) and the work definition table 110a stored in the work definition DB 110, and sets the object of the service Sm, the feature of the service Om, and the destination of the service Cm (acquired in step S116) to the information items “Object of Service,” “Feature of Service,” and “Destination of Service” in the added work definition item. Thereafter, the processing of FIG. 20 is completed.

As described above, when a station receives a recommendation to update the work definition for the station, the station can update the work definition. Specifically, the work definition for the station is rewritten so as not to include the object of the service, the feature of the service, and the destination of the service which are designated in a work request forwarded from the above station to another station, or so as to include the object of the service, the feature of the service, and the destination of the service which are designated in a work request forwarded from another station to the above station.

### 2.10 Examples of Updating

Hereinbelow, examples of updating of work definitions are explained.

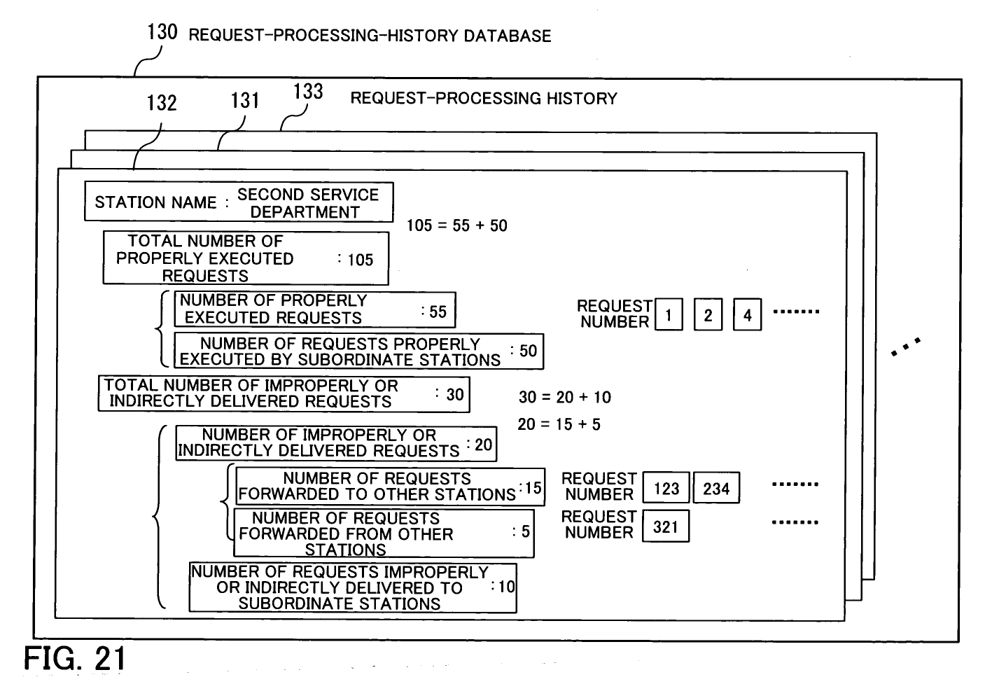

FIG. 21 shows as an example of a request-processing history. The example of FIG. 21 is a request-processing history 132 for the aforementioned Second Service Department. In this example, the value of the information item “Total Number of Properly Executed Requests” is “105,” including the number (“55”) of work requests which have been properly executed by the Second Service Department and the number (“50”) of work requests which have been properly executed by one or more stations subordinate to the Second Service Department. In addition, the value of the information item “Total Number of Improperly or Indirectly Delivered Requests” is “30,” including the number (“20”) of work requests which have been improperly or indirectly delivered to the Second Service Department and the number (“10”) of work requests which have been improperly or indirectly delivered to one or more stations subordinate to the Second Service Department. The number (“20”) of work requests which have been improperly or indirectly delivered to the Second Service Department includes the number (“15”) of work requests which have been forwarded to other stations and the number (“5”) of work requests which have been forwarded from other stations. The request numbers of the work request which have been forwarded to other stations are “123,” “234,” and others, and the work requests which have been forwarded from other stations “321” and others.

It is possible to reduce the number of inappropriate delivery of work requests by referring to the request-processing history 132, excluding from the work definition for each station in charge the extent of the work designated by each work request forwarded from the station in charge to another station, and including the extent of the work designated by each work request forwarded from another station to the station in charge.

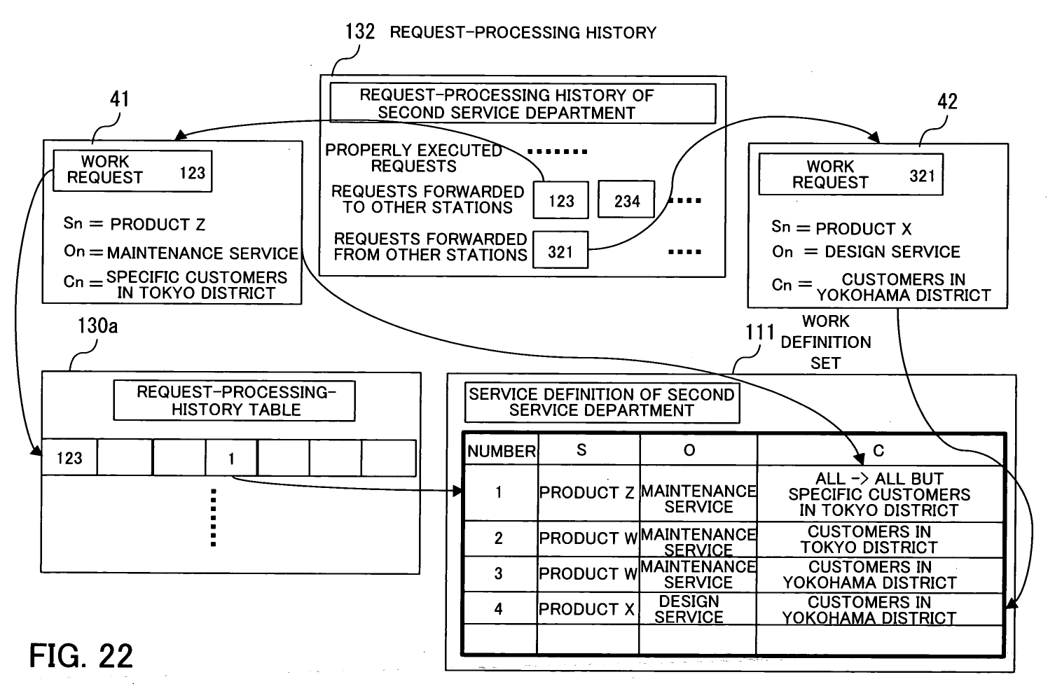

FIG. 22 is a diagram illustrating an example of updating of work definitions. In the example of FIG. 22, the work request 41 is registered in the request-processing history 132 as a work request which has been forwarded to another station. In the work request 41, the information item “Object of Service” indicates “Product Z,” the information item “Feature of Service” indicates “Maintenance Service,” and the information item “Destination of Service” indicates “Specific Customers in Tokyo District.” In the work definition table 110a, the work definitions for the Second Service Department and the Customer-service Headquarters overlap. Therefore, the maintenance service for the product Z to the specific customers in the Tokyo district is included in both of the work definition for the Second Service Department and the work definition for the Customer-service Headquarters.

Assume that the Customer-service Headquarters is predetermined to provide the maintenance service for the product Z to the specific customers in the Tokyo district. In this case, if the “Second Service Department” is designated in a work request for the maintenance service for the product Z to the specific customers in the Tokyo district, the work request is forwarded by a person belonging to the Second Service Department to the Customer-service Headquarters, and the request number of the work request is set in the request-processing history 132 for the Second Service Department as a work request which has been forwarded to another station.

If the number of work requests which have been improperly or indirectly delivered to the Second Service Department exceeds the threshold value as a result of the above forwarding of the work request, a recommendation to update the work definition is sent to the person belonging to the Second Service Department. Thereafter, when the client used by the person belonging to the Second Service Department issues a request for update of the work definition, and the request number “123” of the work request 41 (which has been forwarded to the Customer-service Headquarters) is designated in the request for update, the work definition for the Second Service Department is updated in the work-flow management server 100. Specifically, when the work-flow management server 100 refers to the request-processing-history table 130a on the basis of the request number “123,” the work definition number “1” is obtained. Then, the work-flow management server 100 refers to the work definition item having the work definition number “1” in the work definition set 111.

In the work definition item referred to as above, the information item “Object of Service” indicates “Product Z,” the information item “Feature of Service” indicates “Maintenance Service,” and the information item “Destination of Service” indicates “All.” In order to exclude from the work definition the extent of the work indicated in the work request 41, the information item “Destination of Service” is changed from “All” to “All but Specific Customers in Tokyo District.”

In the example of FIG. 22, the work request 42 is also registered in the request-processing history 132 as a work request which has been forwarded from another station. In the work request 42, the information item “Object of Service” indicates “Product X,” the information item “Feature of Service” indicates “Design Service,” and the information item “Destination of Service” indicates “Customers in the Yokohama District.” When the client used by the person belonging to the Second Service Department issues a request for update of the work definition, and the work request 42 is designated in the request for update, the work-flow management server 100 adds to the work definition set for the Second Service Department a new work definition item corresponding to the work request 42 and having the work definition number of “4.”

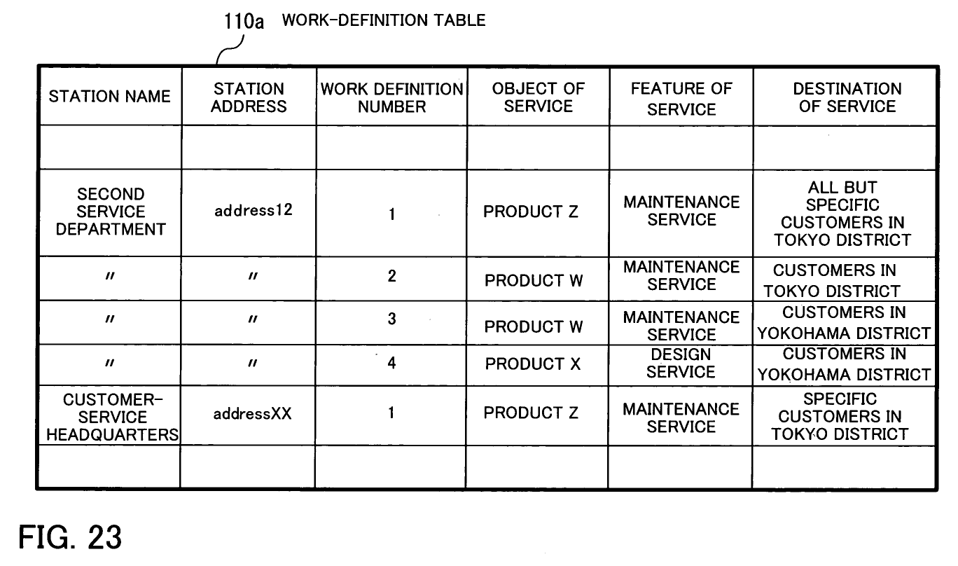

FIG. 23 is a diagram illustrating an example of a work definition table after the work definitions are updated. The information item “Destination of Service” indicates “All but Specific Customers in Tokyo District” in the work definition table 110a after the update indicated in FIG. 23, while the information item “Destination of Service” indicates “All” before the update as indicated in FIG. 7. Thus, it is possible to eliminate the overlap between the work definition for the Second Service Department and the work definition for the Customer-service Headquarters.

In addition, in the example of FIG. 23, the work definition item for the Second Service Department having the work definition number of “4” is added. In the added work definition item, the object of the service is “Product X,” the feature of the service is “Design Service,” and the destination of the service is “Customers in the Yokohama District.” Thereafter, when the work-flow management server 100 receives a work request for an identical work to the work request 42, the Second Service Department is determined to be in charge of executing the received work request.

At this time, the work definition for the Customer-service Headquarters is not changed since the Customer-service Headquarters has properly executed the work request 41, which has been forwarded from the Second Service Department to the Customer-service Headquarters.

As described above, when records of forwarding of work requests are contained in the request-processing histories, it is possible to instruct a person belonging to each station to change the work definition, and easily change the work definition for each station. Specifically, it is possible to change the work definition according to a work request which has been forwarded to another station so as to exclude the extent of the work indicated by the work request. In addition, it is also possible to change the work definition according to a work request which has been forwarded from another station so as to add to the work definition the extent of the work indicated by the work request.

In the above example, when a station having a work definition which covers the extent of the work indicated by a work request is detected, first, the station is determined to be in charge of executing the work request. However, when work definitions for a plurality of different stations overlap, each of the work definitions for the plurality of stations can cover the extent of the work indicated by a work request. In this case, it is possible to make a list of the plurality of stations the work definitions for which cover the extent of the work indicated by the work request, by comparing the extent of the work indicated by each work request with the work definitions for all the stations in the organization.

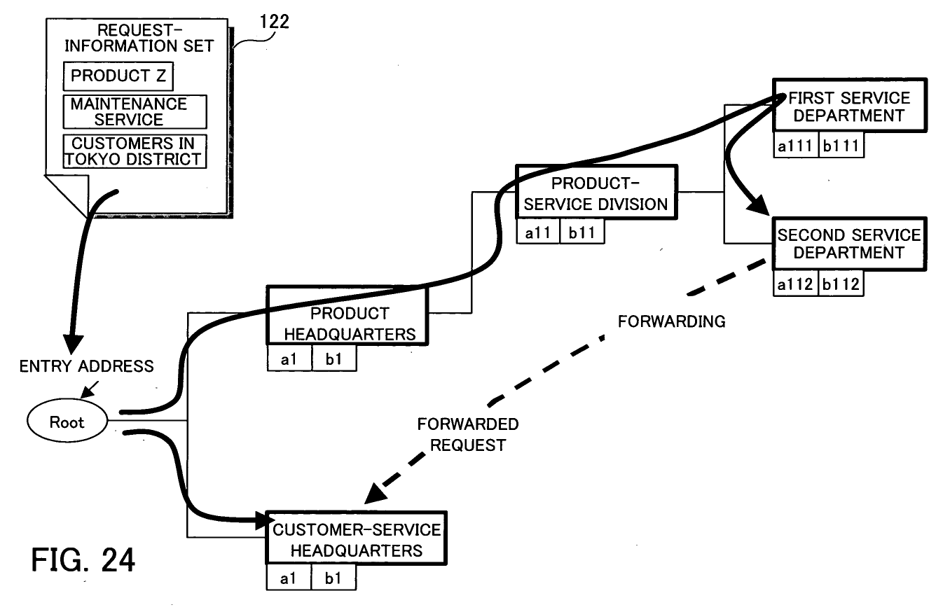

FIG. 24 is a diagram illustrating an example of an operation of making a list of all stations which can execute a work request. In the example of FIG. 24, all the stations subordinate to the station at the entry address are searched, one or more stations each having a work definition which covers the extent of a work indicated by a work request are determined to be candidates for a station in charge of executing the work request, and the candidates are listed in a table. It is possible to search the entire organization by designating as the entry address the address of the station at the top (root) of the organization.

In the example of FIG. 24, a work definition corresponding to the extent of the work designated in a work request (request-information set) 122 is set for each of the Second Service Department and the Customer-service Headquarters. The comparison unit 143 searches all the stations subordinate to the station as the entry for one or more stations each having a work definition which covers the extent of the work designated by the work request 122, and lists the one or more stations detected by the search, in a table of candidates.

Then, the comparison unit 143 sets an appropriate one of the one or more stations listed in the table as a station in charge, and passes the work request 122 to the request handling unit 144, so that the work request 122 is delivered by the request output unit 145 to the station in charge. A person belonging to the station in charge determines whether to accept the work request 122 on receipt of the work request 122.

When the station which is first designated as a station in charge rejects the work request, the request handling unit 144 makes the client used by the person belonging to the station display the table of candidates for a new station in charge. Then, the person belonging to the station to which the work request is first delivered selects one of the candidates as a destination to which the work request is to be forwarded, and inputs information indicating the selected one into the client, so that the request handling unit 144 receives the information indicating the selected station, and forwards the work request to the selected station.

In the example of FIG. 24, the wrong station (the Second Service Department) is first set as a station in charge. Then, the person belonging to the Second Service Department can recognize that the Customer-service Headquarters is an appropriate station in charge, and can therefore input the information indicating the selected one of the candidates into the client. Thus, the work request 122 can be forwarded to the Customer-service Headquarters. As described above, when the list of the candidates for the station in charge is displayed to the person in charge, it is possible to recognize the appropriate station at an early stage.

Further, according to some processing methods, the processing for confirmation whether or not the work definitions for stations overlap (in step S12 in FIG. 12) may be dispensed with. That is, according to such processing methods, overlap between work definitions for different stations is allowed in the preprocessing stage. Therefore, it is unnecessary to recommend updating of the work definition in the preprocessing stage. However, the overlap between work definitions is ultimately required to be eliminated. Thus, in the case where the overlap between work definitions is not eliminated in the preprocessing stage, the recommendation to update the work definition is issued in the postprocessing stage.

### 3. Second Embodiment

The work-flow system according to the second embodiment of the present invention can operate in a mode of storing work definitions, and can specifically operate in an initial storage mode and a normal mode. The work definitions are learned in the initial storage mode, and updated in the normal mode.

The work-flow system according to the second embodiment of the present invention has a system construction similar to the first embodiment. However, the functions and operations of the work-flow management server are different from the first embodiment.

Hereinbelow, the functions and operations according to the second embodiment which are different from the functions and operations according to the first embodiment are explained.

### 3.1 Functions of Work-flow Management Server

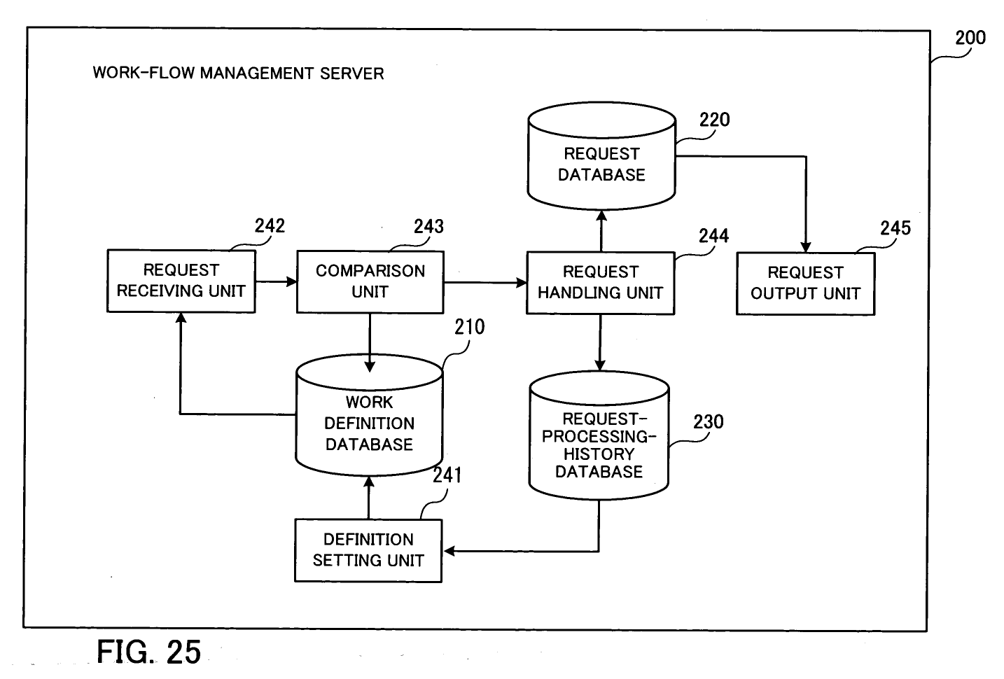

FIG. 25 is a block diagram illustrating the functions of the work-flow management server according to the second embodiment of the present invention. The work-flow management server 200 illustrated in FIG. 25 comprises a work definition database (DB) 210, a request DB 220, a request-processing-history DB 230, a definition setting unit 241, a request receiving unit 242, a comparison unit 243, a request handling unit 244, and a request output unit 245. The work definition database (DB) 210, the request DB 220, the request-processing-history DB 230, the request receiving unit 242, the comparison unit 243, the request handling unit 244, and the request output unit 245 have functions similar to the elements of the same names in the work-flow management server 100 indicated in FIG. 4, respectively.

The definition setting unit 241 automatically sets the work definitions according to the status of processing of work requests.

### 3.2 Data Structure of Request DB

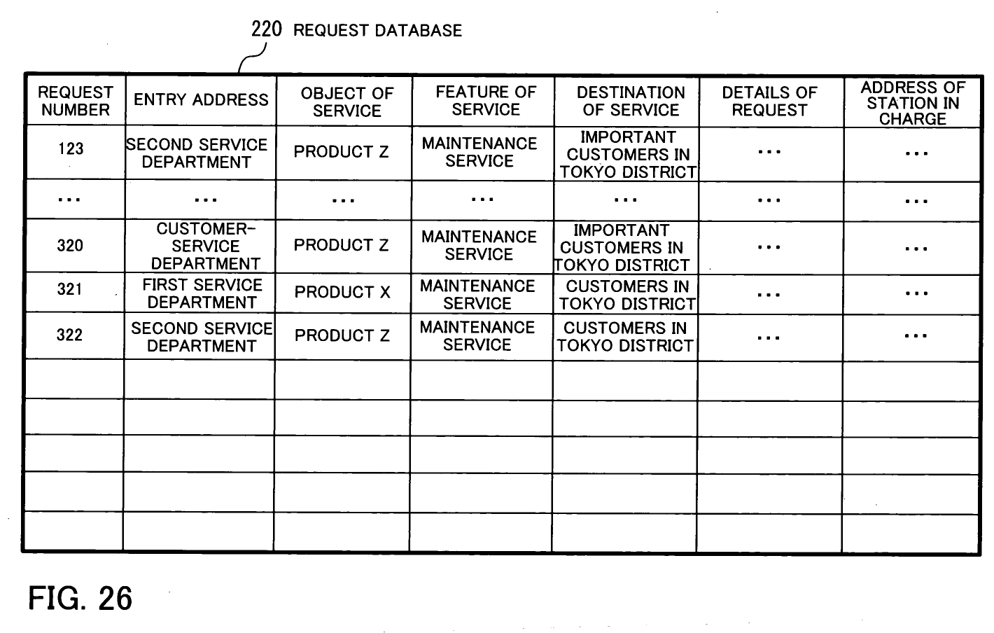

FIG. 26 is a diagram illustrating an example of a data structure of the request DB 220. The request DB 220 has the fields of “Request Number,” “Entry Address,” “Object of Service,” “Feature of Service,” “Destination of Service,” “Details of Request,” and “Address of Station in Charge.” Each row of the table of FIG. 26 corresponds to a request-information set as the request-information sets 121, 122, 123, . . . indicated in FIG. 8.

### 3.3 Processing Sequences

Hereinbelow, sequences of processing according to the second embodiment are explained.

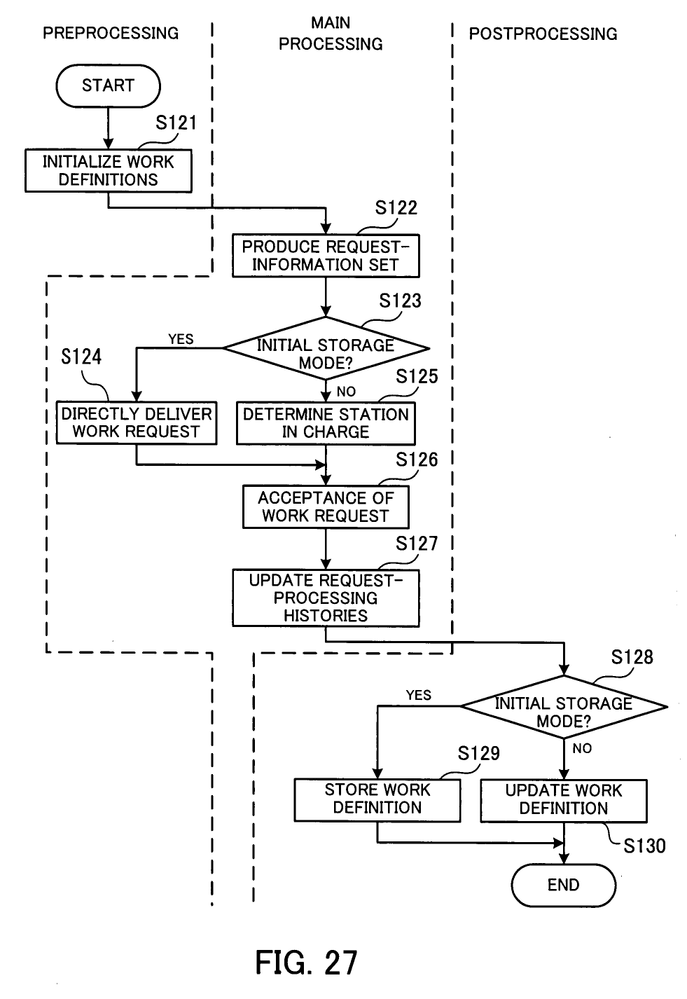

FIG. 27 is a flow diagram indicating a sequence of processing according to the second embodiment. The processing of FIG. 27 includes preprocessing (step S121), main processing (steps S122 to S127), and postprocessing (steps S128 to S130). The processing indicated in FIG. 27 is explained below step by step.

<Step S121> The definition setting unit 241 initializes the work definitions for and request-processing histories of all the stations.

<Step S122> The request receiving unit 242 produces a request-information set in response to an input of a work request from a client. The produced request-information set is passed to the comparison unit 243.

<Step S123> The comparison unit 243 determines the operational mode, which is the initial storage mode or the normal mode. The current operational mode is stored in a memory managed by the definition setting unit 241. When the operation of the system is started, the definition setting unit 241 starts its operation in the initial storage mode. Thereafter, when a condition for ending the initial storage mode is satisfied (for example, when the number of executed work requests exceeds a predetermined threshold value), the definition setting unit 241 switches the operational mode from the initial storage mode to the normal mode. The comparison unit 243 acquires information on the operational mode from the definition setting unit 241, and determines the current operational mode. When the operational mode is the initial storage mode, the operation goes to step S124. When the operational mode is the normal mode, the operation goes to step S125.

<Step S124> In the initial storage mode, the comparison unit 243 directly delivers the work request (request-information set) received in step S122 to an appropriate station. Thereafter, the operation goes to step S126.

<Step S125> In the normal mode, the comparison unit 243 searches for a station having a work definition which covers the extent of the work indicated by the request-information set, by tracing the tree structure of the organization. Then, the comparison unit 243 determines the station detected by the search to be a station in charge. That is, when the comparison unit 243 detects a station having a work definition which covers the extent of the work indicated by the request-information set, the comparison unit 243 sets the value of the information item “Station Address” in the work definition as the information item “Address of Station in Charge” in the request-information set. Details of the processing in step S125 are similar to the processing according to the first embodiment described with reference to FIG. 16.

<Step S126> The request handling unit 244 receives the request-information set from the comparison unit 243, and stores the request-information set in the request DB 220. Thereafter, when the work-flow management server 200 receives a request for delivery of a work request from a client used by a person belonging to a station in charge of a work operation indicated by the work request, the request output unit 245 delivers the work request to the client. In addition, when work-flow management server 200 receives an instruction to forward the work request from a person belonging to the station in charge, the request handling unit 244 forwards the work request to another station. Further, when the work-flow management server 200 receives information indicating acceptance of the work request, from the station in charge of the work request or the station to which the work request has been forwarded, the request handling unit 244 completes the processing for forwarding the work request. Details of the processing in step S125 are similar to the processing according to the first embodiment described with reference to FIG. 17.

<Step S127> The request handling unit 244 updates one or more request-processing histories on the basis of a record of processing performed after the work request is received by the work-flow management server 200 until the work request is accepted by a station.

<Step S128> The definition setting unit 241 determines the operational mode. When the operational mode is the initial storage mode, the operation goes to step S129. When the operational mode is the normal mode, the operation goes to step S130.

<Step S129> In the initial storage mode, every time a work request is executed, the definition setting unit 241 refers to a request-processing history, and stores in the work definition DB 210 a description of a work operation indicated in the work request as a work definition item for a station which executes the work request. Thereafter, the processing of FIG. 27 is completed.

<Step S130> In the normal mode, every time a work request is executed, the definition setting unit 241 refers to the request-processing histories, and updates one or more work definitions for one or more stations concerned in the handling of the work request on the basis of one or more request-processing histories of the one or more stations each indicating forwarding from a station in charge to another station or from another station to the station in charge. Thereafter, the processing of FIG. 27 is completed.

Next, the processing in each part of the sequence of FIG. 27 is explained in detail below.

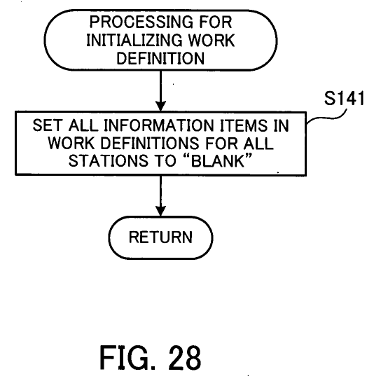

FIG. 28 is a flow diagram indicating a sequence of processing for initializing work definitions.

<Step S141> The definition setting unit 241 sets all the information items in the work definitions for all the stations to “blank.”

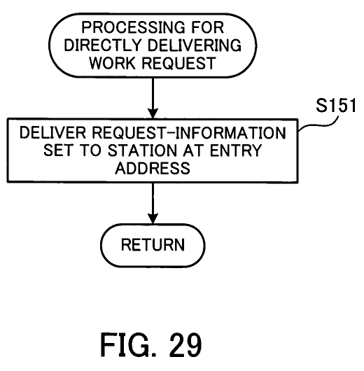

FIG. 29 is a flow diagram indicating a sequence of processing for directly delivering a request-information set.

<Step S151> The comparison unit 243 delivers a request-information set to a station at the entry address. Specifically, the comparison unit 243 sets the station at the entry address as a station in charge by setting the value of the information item “Entry Address” in the request-information set as the information item “Address of Station in Charge” in the request-information set.

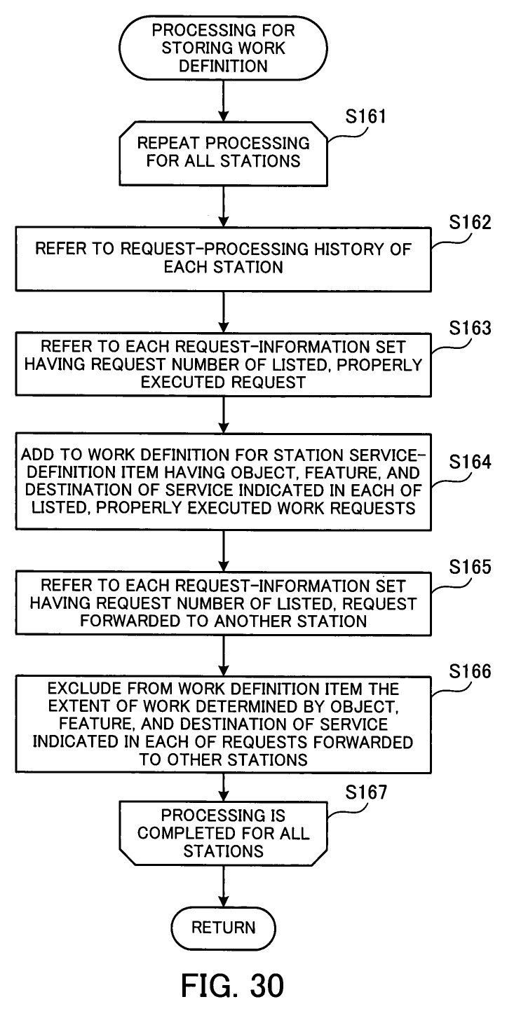

FIG. 30 is a flow diagram indicating a sequence of processing for storing the work definitions. The processing indicated in FIG. 30 is explained below step by step.

<Step S161> The definition setting unit 241 performs the processing in steps S162 to S166 for every station.

<Step S162> The definition setting unit 241 refers to the request-processing history of the station.

<Step S163> The definition setting unit 241 refers to a request-information set having each of one or more request numbers which are listed as the properly executed requests in the request-processing history of the station.

<Step S164> The definition setting unit 241 adds a work definition item having the object of the service, the feature of the service, and the destination of the service which are indicated in each of the properly executed work requests to the work definition for the above station.

<Step S165> The definition setting unit 241 refers to a request-information set having each of one or more request numbers which are listed as the requests forwarded to other stations in the request-processing history of the station.

<Step S166> When the work definition for the above station includes a work definition item overlapping the extent of the work determined by the object of the service, the feature of the service, and the destination of the service indicated in each of the requests forwarded to other stations, the definition setting unit 241 excludes the extent of the work from the work definition item.

<Step S167> When the processing in steps S162 to S166 is completed for all the stations, the processing of FIG. 30 is completed.

As described above, in the initial storage mode, work requests are accepted, and records of processing of the work requests are registered. Thereafter, a work definition for each station is stored, where a work definition item having the object of the service, the feature of the service, and the destination of the service which are indicated in each work request which has been properly executed by the above station is added to the work definition for the station on the basis of the request-processing history of the station, and the extent of the work determined by the object of the service, the feature of the service, and the destination of the service indicated in each work request which has been improperly or indirectly delivered to the above station is excluded from the work definition for the station on the basis of the request-processing history of the station.

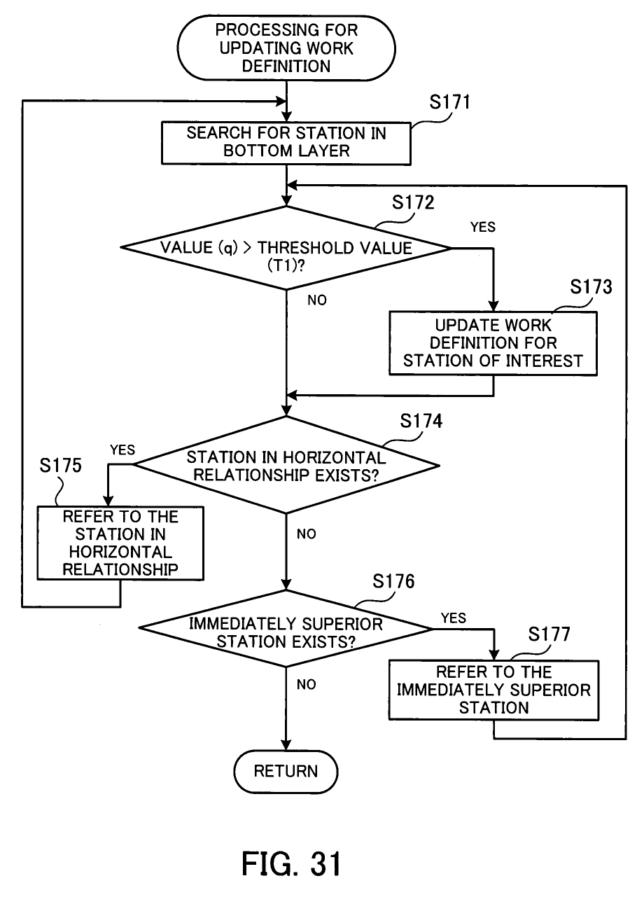

FIG. 31 is a flow diagram indicating a sequence of processing for updating the work definitions. The processing indicated in FIG. 31 is explained below step by step.

<Step S171> The definition setting unit 241 searches for a station in a bottom layer in the organization subordinate to a station of interest. It is assumed that the station of interest is the station at the root when the processing of FIG. 31 is started. Then, the definition setting unit 241 refers to the work definition for the station in the bottom layer.

<Step S172> The definition setting unit 241 determines whether or not the value (q) of the information item “Total Number of Improperly or Indirectly Delivered Requests” exceeds the preset threshold value (T1). When yes is determined, the operation goes to step S173. When no is determined, the operation goes to step S174.

<Step S173> The definition setting unit 241 updates the work definition for the station of interest. Details of the processing in step S173 are similar to the processing for updating work definitions according to the first embodiment described with reference to FIG. 20. In this case, processing for excluding from the work definition the extent of the works indicated in all work requests forwarded from the station of interest to another station and processing for adding to the work definition the extent of the works indicated in all work requests forwarded from another station to the station of interest are performed.

<Step S174> The definition setting unit 241 determines whether or not a station which has a horizontal relationship with the station of interest and has not yet been executed in the sequence of FIG. 31 exists. When yes is determined, the operation goes to step S175. When no is determined, the operation goes to step S176.

<Step S175> The definition setting unit 241 determines the station detected in step S174 to be the station of interest. Thereafter, the operation goes to step S171.

<Step S176> The definition setting unit 241 determines whether or not a station immediately superior to the station of interest exists. When yes is determined, the operation goes to step S177. When no is determined, the processing indicated in FIG. 31 is completed.

<Step S177> The definition setting unit 241 determines the station detected in step S176 to be the station of interest. Thereafter, the operation goes to step S172.

As described above, it is possible to update the work definitions. For example, overlap between work definitions can be corrected.

### 4. Recording Medium Storing Program

The processing functions of the work-flow management servers according to the first and second embodiments which are explained above can be realized by computers. In this case, a program describing details of processing for realizing the functions which each work-flow management server should have is provided. When the computer executes the program, the processing functions of the work-flow management server can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium, or is initially transferred from the server computer. The computer reads the program from the storage device, and performs processing in accordance with the program. Alternatively, the computer may directly read the program from the portable recording medium for performing processing in accordance with the program. Further alternatively, the computer can sequentially execute processing in accordance with each portion of the program every time the portion of the program is transferred from the server computer.

### 5. Advantages

As explained above, according to the present invention, a request-processing history is produced and stored on the basis of acceptance information indicating whether or not a station in charge accepts each work request, and a station at which the number of improperly or indirectly delivered requests (including rejected requests) exceeds a predetermined number is detected, so that it is possible to detect a mismatch between a work definition for each station and a work operation actually performed by the station.

### 6. Additional Matter

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable medium storing a work-flow program which makes a computer realize a work-flow apparatus for delivering work requests for work operations to a plurality of stations in an organization, said work-flow apparatus comprising:
a work definition storing unit which stores a plurality of work definitions for said plurality of stations, where a plurality of work operations to be performed by the plurality of stations are defined in the plurality of work definitions, respectively;
a history storing unit which stores request-processing histories of said plurality of stations, where the request-processing histories indicate how one or more work requests have been handled by stations designated to be in charge of executing the one or more work requests;
a request receiving unit which receives a work request for a work operation;
a station-in-charge determination unit which detects a station for which a work definition covering the work operation requested by the work request is stored in said work definition storing unit, by comparing the work request received by said request receiving unit with said plurality of work definitions stored in the work definition storing unit, and determines the detected station to be a station in charge of executing the work request;
a request output unit which delivers said work request to a terminal used in said station in charge;
an acceptance-determination acquisition unit which acquires from said terminal acceptance information indicating whether or not said station in charge accepts said work request which is delivered by said request output unit, and reflects the acceptance information in the request-processing histories so that the acceptance information is associated with an identifier of the work request; and
a definition-to-be-corrected detection unit which obtains as a statistic for each of the plurality of stations the number of work requests which have been improperly or indirectly delivered to said each of the plurality of stations, on the basis of the numbers of work requests which have been rejected by said each of the plurality of stations, and detects one of the plurality of stations for which said statistic is equal to or greater than a predetermined number, as a station for which one of said plurality of work definitions is to be corrected, where the numbers of work requests which have been rejected by the plurality of stations are respectively indicated in said request-processing histories stored in said history storing unit.

2. The computer-readable medium according to claim 1, wherein said definition-to-be-corrected detection unit sends a first instruction to correct said one of the plurality of work definitions to a terminal used in said station detected by the definition-to-be-corrected detection unit.

3. The computer-readable medium according to claim 2, wherein said work-flow apparatus further comprises a work definition update unit, and when said acceptance information indicates that said station in charge rejects said work request, and said station detected by said definition-to-be-corrected detection unit is said station in charge, and said terminal used in said station in charge receives said first instruction from said definition-to-be-corrected detection unit, and the work definition update unit receives a second instruction to correct said one of the plurality of work definitions from said terminal used in said station in charge, and the work request is designated in the second instruction, the work definition update unit corrects the one of the plurality of work definitions by excluding said work operation requested by the work request, from the one of the plurality of work definitions stored in said work definition storing unit.

4. The computer-readable medium according to claim 1, wherein when said acceptance information indicates that said station in charge rejects said work request, said acceptance-determination acquisition unit acquires from said terminal forwarding information designating a destination to which said work request is to be forwarded, and updates the plurality of work definitions in said work definition storing unit so that the forwarding information is associated with the identifier of the work request, and
said definition-to-be-corrected detection unit obtains said statistic on the basis of a sum of the number of work requests which have been rejected by said each of the plurality of stations and the number of work requests which have been forwarded to said each of the plurality of stations.

5. The computer-readable medium according to claim 4, wherein said definition-to-be-corrected detection unit sends a first instruction to correct said one of the plurality of work definitions to a terminal used in said station detected by the definition-to-be-corrected detection unit, and
said work-flow apparatus further comprises a work definition update unit, and when said work request is forwarded from said station in charge to another of the plurality of stations, and said station detected by said definition-to-be-corrected detection unit is said another of the plurality of stations, and another terminal used in said another of the plurality of stations receives said first instruction from said definition-to-be-corrected detection unit, and the work definition update unit receives a second instruction to correct said one of the plurality of work definitions from said another terminal used in said another of the plurality of stations, and the work request is designated in the second instruction, the work definition update unit corrects the one of the plurality of work definitions by adding said work operation requested by the work request, to the one of the plurality of work definitions stored in said work definition storing unit.

6. The computer-readable medium according to claim 1, wherein each of said plurality of work definitions defines a work operation by information specifying an article as an object of a service, information indicating a feature of the service, and information indicating a destination of the service.

7. The computer-readable medium according to claim 1, wherein said plurality of stations are arranged in a tree structure in said organization, and said work-flow apparatus further comprises a history update unit, and when one or more stations exist subordinate to said each of the plurality of stations, the history update unit calculates said statistic for each of the plurality of stations by accumulating the numbers of work requests which have been improperly or indirectly delivered to said each of the plurality of stations and the one or more of the plurality of stations subordinate to said each of the plurality of stations.

8. The computer-readable medium according to claim 1, wherein said work-flow apparatus further comprises a work definition setting unit which operates in either of an initial storage mode and a normal mode, and in a case where the work definition setting unit operates in the initial storage mode, the work definition setting unit refers to said work definition storing unit, adds to a work definition for each station one or more work operations requested by one or more work requests when the one or more requests are accepted by each station, and excludes from the work definition for said each station one or more work operations requested by one or more work requests when the one or more work requests are rejected by said each station.

9. The computer-readable medium according to claim 8, wherein when the work definition setting unit operates in the normal mode, and said definition-to-be-corrected detection unit detects said station for which said one of the plurality of work definitions is to be corrected, the work definition setting unit adds to said one of the plurality of work definitions a work operation requested by a work request accepted by said station detected by the definition-to-be-corrected detection unit, and excludes from said one of the plurality of work definitions a work operation requested by a work request rejected by said station detected by the definition-to-be-corrected detection unit.

10. A work-flow apparatus for delivering work requests for work operations to a plurality of stations in an organization, said work-flow apparatus comprising:
a work definition storing unit which stores a plurality of work definitions for said plurality of stations, where work operations to be performed by the plurality of stations are defined in the plurality of work definitions, respectively;
a history storing unit which stores request-processing histories of said plurality of stations, where the request-processing histories indicate how one or more work requests have been handled by stations designated to be in charge of executing the one or more work requests;
a request receiving unit which receives a work request for a work operation;
a station-in-charge determination unit which detects a station for which a work definition covering the work operation requested by the work request is stored in said work definition storing unit, by comparing the work request received by said request receiving unit with said plurality of work definitions stored in the work definition storing unit, and determines the detected station to be a station in charge of executing the work request;
a request output unit which delivers said work request to a terminal used in said station in charge;
an acceptance-determination acquisition unit which acquires from said terminal acceptance information indicating whether or not said station in charge accepts said work request which is delivered by said request output unit, and reflects the acceptance information in the request-processing histories so that the acceptance information is associated with an identifier of the work request; and
a definition-to-be-corrected detection unit which obtains as a statistic for each of the plurality of stations the number of work requests which have been improperly or indirectly delivered to said each of the plurality of stations, on the basis of the numbers of work requests which have been rejected by said each of the plurality of stations, and detects one of the plurality of stations for which said statistic is equal to or greater than a predetermined number, as a station for which one of said plurality of work definitions is to be corrected, where the numbers of work requests which have been rejected by the plurality of stations are respectively indicated in said request-processing histories stored in said history storing unit.

11. A work-flow process for delivering work requests for work operations to a plurality of stations in an organization, comprising the steps of:
(a) receiving a work request for a work operation;
(b) detecting a station for which a work definition covering the work operation requested by the work request is stored in advance, by comparing the work request received in step (a) with a plurality of work definitions which are stored in advance, and determining the detected station to be a station in charge of executing the work request;
(c) delivering said work request to a terminal used in said station in charge;
(d) acquiring from said terminal acceptance information indicating whether or not said station in charge accepts said work request which is delivered in step (c), and reflecting the acceptance information in request-processing histories so that the acceptance information is associated with an identifier of the work request; and
(e) obtaining as a statistic for each of the plurality of stations the number of work requests which have been improperly or indirectly delivered to said each of the plurality of stations, on the basis of the numbers of work requests which have been rejected by said each of the plurality of stations, and detecting one of the plurality of stations for which said statistic is equal to or greater than a predetermined number, as a station for which one of said plurality of work definitions is to be corrected, where the numbers of work requests which have been rejected by the plurality of stations are respectively indicated in request-processing histories, which are stored in advance in correspondence with the plurality of stations, respectively.
